(19) United States
(12) Patent Application Publication
(10) Pub. No.: US 2022/0165208 A1
(43) Pub. Date: May 26, 2022

(54) HYBRID PIXEL BACKPLANE AND DRIVING METHOD

(71) Applicant: Jasper Display Corp., Grand Cayman (KY)

(72) Inventors: Kaushik Sheth, Santa Clara, CA (US); Bo Li, Santa Clara, CA (US); Edwin Lyle Hudson, Santa Clara, CA (US); Jeffrey Li, Santa Clara, CA (US); Robert Lo, Santa Clara, CA (US); David Charles McDonald, Santa Clara, CA (US)

(21) Appl. No.: 17/521,993

(22) Filed: Nov. 9, 2021

Related U.S. Application Data
(60) Provisional application No. 63/118,071, filed on Nov. 25, 2020.

(51) Int. Cl. G09G 3/32

(52) U.S. Cl. CPC G09G 3/32; G09G 2310/027; G09G 2300/0857

(57) ABSTRACT

A method for providing gray scale for an array of current emissive devices sensitive to the current level driving them, such as an LEDs, is disclosed. Multiple current sources are operated in parallel for each emissive device with the on/off state of each of the multiple current source controlled by a memory circuit. Means for pulse width modulating the array of current sensitive devices to enable greater control over gray scale is presented.

### CROSS-REFERENCE TO RELATED APPLICATIONS

This application claims the benefit of U.S. Provisional Patent Application 63/118,071, filed on Nov. 25, 2020.

### FIELD OF THE INVENTION

The present invention relates to the design of a backplane useful to drive an array of blocks of pixel drive circuits comprising emissive devices at each block of pixel drive circuits and to an emissive array fabricated with such a backplane. More particularly, the present invention relates to a backplane designed such that it can drive an array of micro emissive pixel drive circuits digitally with stepwise current increases to control gray scale.

### BACKGROUND OF THE INVENTION

Emissive displays have proved useful for a variety of applications. For example, plasma display panels (PDPs) were at one time the leading flat panel display technology. More recently, applications that are not display oriented have been postulated, including use as a pixilated emissive device in an additive manufacturing device and use as a component within a vehicular illumination system for automotive headlamp applications.

More recently, emissive display system developers have demonstrated emissive displays based on backplanes driving small LEDs with a pitch between adjacent pixels of 17 micrometers (hereafter microns or μm) or less. For applications requiring higher brightness the small LEDs may be made larger although still small—on the order of 40 to 50 microns. The sizes stated are not limiting on this specification. These small LEDs are commonly termed microLEDs or μLEDs. LEDs take advantage of the band gap characteristic of semiconductors in which use of a suitable voltage to drive the LED will cause electrons within the LED to combine with electron holes, resulting in the release of energy in the form of photons, a feature referred to as electroluminescence. Those of skill in the art will recognize that semiconductors suitable for LED components may include trace amounts of dopant material to facilitate the formation of electron holes. Organic light emitting diodes or OLEDs are another example of a class of emissive devices.

The choice of semiconductor materials used to form an LED will vary by application. In some applications for visual displays one monochrome color may be desirable, resulting in the use of a single semiconductor material or an identical combination of semiconductor materials for the LEDs of all pixels. Some LEDs provide white light by using blue light to illuminate a phosphor material suitable to provide green and red light, which, combined with the blue light, is perceived as white in color. In other applications, a full range of colors may be required, which will result in a requirement for three or more semiconductor materials configured to radiate, for example, red, green and blue or combinations thereof. An illumination system based on LEDs may be applied to use in a variety of applications, including motor vehicle lights and head lamps. In the case of additive manufacturing, a semiconductor material may be selected such that it emits radiation at a wavelength that acts as actinic radiation on a material used in an additive manufacturing process. All potential variations are included within the scope of the present invention.

### SUMMARY OF THE PRESENT INVENTION

The present invention pertains to a backplane comprising blocks of pixel drive circuits operative to deliver a spatially modulated high current to an emissive device mounted on a common electrode for each block. More particularly, it pertains to a backplane suitable for use as part of a headlamp illumination system that a spatial selection of pixel drive circuits that enable gray scale variation based on the data loaded to a set of memory circuits resident in each block.

### BRIEF DESCRIPTION OF THE DRAWINGS

FIG. 1A depicts the external and internal data transfer sections of a spatial light modulator backplane.

FIG. 1B presents a view of a spatial light modulator backplane controller integrated with spatial light modulator a backplane comprising pixel drive circuits.

FIG. 2A presents a block diagram of a pixel drive circuit.

FIG. 2B presents a schematic diagram of a pixel drive circuit.

FIG. 3 depicts a simplified diagram of a block of pixel drive circuits.

FIG. 4A depicts a block of pixel drive circuits organized spatially into subblocks with a majority of the subblocks representing binary weighted current supply circuits.

FIG. 4B depicts a block of pixel drive circuits organized spatially into subblocks with all of the subblocks representing binary weighted current supply circuits with some repetition of the currents.

FIG. 4C depicts a block of pixel drive circuits organized into a 6 by 4 pixel drive circuit array.

FIG. 4D depicts a method of modulating a backplane comprising blocks of pixel drive circuits wherein one word line addresses all the memory circuits of a row of blocks of pixel drive circuits.

FIG. 5A depicts two pixel drive circuits controlled by a single memory circuit.

FIG. 5B depicts two pixel drive circuits sharing a single bias FET controlled by a single memory circuit.

FIG. 5C depicts a current mirror circuit comprising a single memory circuit, reference current FET and two current source FETs.

FIG. 6A depicts a block of pixel drive circuits its wherein two separate word lines are required to address the memory circuits of all pixel drive circuits of the block of pixel drive circuits.

FIG. 6B depicts a block diagram of a spatial light modulator backplane controller integrated with spatial light modulator a backplane comprising blocks of pixel drive circuits.

FIGS. 6C and 6D depict a modulation scheme for pulse width modulating blocks of pixel drive circuits comprising elements of an array of pixel drive circuits.

### DETAILED DESCRIPTION OF THE INVENTION

One aspect of the present invention is the use of multiple pixel drive circuits that are in parallel that supply independently modulated current components to a common pad. In a finished product incorporating the disclosed backplane, the anode of each emissive device such as an LED or a μLED is electrically and physically mounted or affixed to the pad and the cathodes of all emissive devices are electrically connected in a common cathode arrangement. The multiple pixel drive circuits may be arranged in a block of m columns by n rows of circuits where m and n may both fall in the range of 4 to 8 columns. Other dimensions for a block of parallel pixel drive circuits may be considered. The block may be square or rectangular. The backplane of a display comprises a plurality of blocks of pixel drive circuits in both rows and columns.

A number of physical embodiments are presented. In a first physical embodiment, each of the multiple pixel drive circuits comprises a memory circuit, such as a 6 transistor SRAM circuit wherein the memory state of the memory circuit determines if the pixel drive circuit is emitting current. Applicant has long developed circuits for pulse width modulating liquid crystal devices using such logic and has comprehensive understanding that the same general approach can be applied to pulse width modulating emissive devices. Each block of pixel drive circuits comprises m×n pixel drive circuits. Several different modulation embodiments will be presented.

In a second physical embodiment, the m by n pixel drive circuits are divided into a set of binary weighted sub-blocks of pixel drive circuits. The binary weighting is by current and not necessarily by area or other metrics although increased current is most likely to require increased area. In one embodiment, the m by n pixel drive circuits may be divided into a set of binary weighted sub-blocks of pixel drive circuits and a set of non-binary weighted sub-blocks of pixel drive circuits. In one implementation, all pixel drive circuits assigned to the same sub-block are modulated by a common memory circuit so that all enter the same state at the same time. In a preferable arrangement, all the memory circuits are located on the same row.

In one embodiment of the foregoing circuits, some pixel drive circuits may share a common large L FET to bias the current provided to a required voltage. This sharing may occur across the boundary between two or more blocks of pixel drive circuits.

The previously mentioned modulation methods may be based in part on modulation methods described in U.S. patent application Ser. No. 10/435,427, now U.S. Pat. No. 8,421,828, and to its continuations, U.S. patent application Ser. No. 13/790,120, now U.S. Pat. No. 9,583,031, and U.S. patent application Ser. No. 15/408,869, now U.S. Pat. No. 9,824,619, all of which are incorporated herein by reference and hereafter referred to as U.S. patent application Ser. No. 10/435,427 and its continuations or with similar language.

These and other objects and advantages of the present invention will no doubt become obvious to those of ordinary skill in the art after having read the following detailed description of the preferred embodiments, which is illustrated in the various drawing figures.

In the present application, the preceding general description and the following specific description are exemplary and explanatory only and are not restrictive of the invention as claimed. It should be noted that, as used in the specification and the appended claims, the singular forms “a”, “an” and “the” include plural referents unless the context clearly dictates otherwise. Thus, for examples, reference to a material may include mixtures of materials; reference to a display may include multiple display, and the like. Use of the word display is synonymous with the term array of pixels as well as other similar terms. A device termed a display need not be used as a means for presenting information for human viewing and may include an array of pixels for any use as previously noted. All references cited herein are hereby incorporated by reference in their entirety, except to the extent that they conflict with teachings explicitly set forth in this specification. The terms MOSFET transistor, FET transistor, FET and transistor are considered to be equivalent. All transistors described herein are MOSFET transistors unless otherwise indicated. Those of skill in the art will recognize that equivalent circuits may be created in nMOS silicon or pMOS silicon.

The present application deals with binary data used for a modified form of pulse width modulation. The modification will be made clear in the disclosure of the invention. Although common practice in pulse width modulation is to use the number 1 to indicate an on state and the number 0 to indicate an off state, this convention is arbitrary and may be reversed, as is well known in the art. Similarly, the use of the terms high and low to indicate on or off is arbitrary and, in the area of circuit design, misleading, because p-channel FETs are in a conducting state (on) when the gate voltage is low and in a nonconducting state (off) when the gate voltage is high. The use of the word binary means that the data represents one of two states. Commonly the two states are referred to as on or off. It does not mean that the duration in time of binary elements of data is also binary weighted although that may be indicated in the descriptive text. In emissive displays such as those of the present invention, it is often possible for a pixel of the emissive display to achieve an off state that is truly off, in that no noticeable residual leakage of light from that pixel occurs when the data state of the circuit driving a pixel of the emissive device is placed to off.

The term conductor shall mean a conductive material, such as copper, aluminum, or polysilicon, operative to carry a modulated or unmodulated voltage or signal. The word wire shall have the same meaning as the term conductor. The word terminal shall mean a connection point to a circuit element. A terminal may be a conductor or a node or other construct. Conductors shall be represented by solid lines unless otherwise indicated. Lines that cross one another are not considered to be electrically connected unless there is a solid connection dot placed over the intersection.

The present application makes use of current mirror circuits, the simplest forms of which are well known in the art. A minimal current mirror circuit comprises two p-channel FETs that may be duplicates of each other and one n-channel FET that biases the current applied to the gate of the current source FET to a designed voltage level. A circuit of similar performance may be implemented in two n-channel FETs and one p-channel bias FET. The terminology describing the components of a current mirror circuit is not consistent across various documents. In the present application, the device generating the reference current to be cloned is called a reference current FET and the current it generates is the reference current or I_{REF}. The device that sets the voltage level of the reference current is the bias FET and the voltage level it sets is the reference voltage or V_{REF}. Thus the reference is current I_{REF} at potential V_{REF}. The device that receives the reference current at the designed reference voltage is the current source FET. Its output is termed the output current with appropriate qualifiers as required for clarity. The term selected reference voltage may be used in place of designed reference voltage with the same intended meaning. It is understood that the delivered reference voltage may differ slightly from the intended design voltage due to process variations. In a well designed circuit, the designed voltage should be substantially the same as the voltage delivered during operation of the circuit.

Although not shown, current sources that are not current mirror are also known in the art and are included in the present invention. An example is disclosed in U.S. patent application Ser. No. 16/802,100, now U.S. Pat. No. 10,957,272, the contents whereof are incorporated herein by reference. This kind of circuit may be applied with some suitable modifications in the present invention.

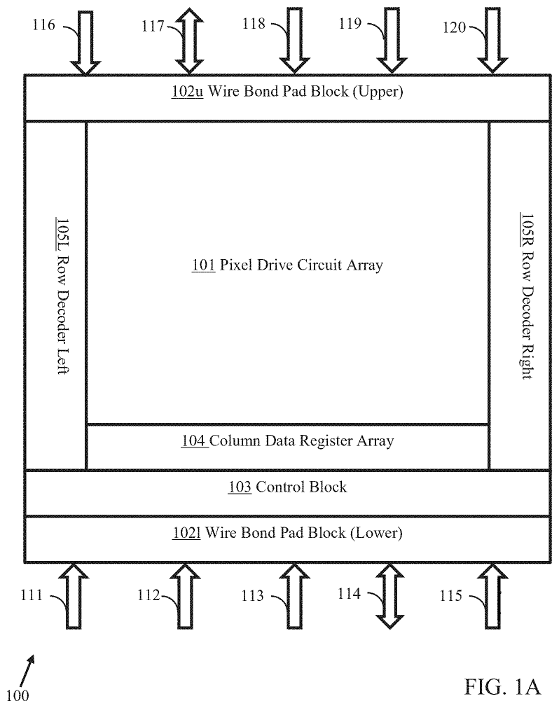

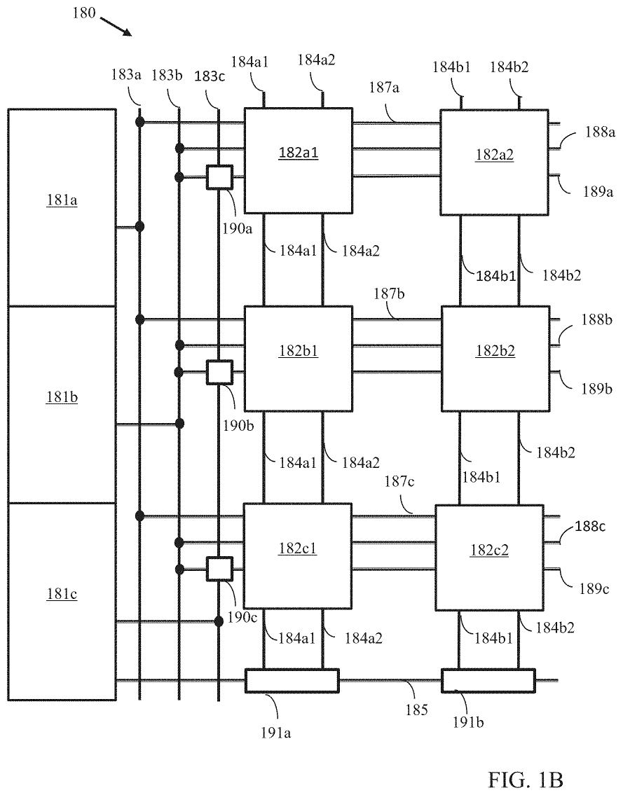

FIG. 1A presents a diagram of the data transfer sections and selected external interfaces of spatial light modulator (SLM) 100. SLM 100 comprises pixel drive circuit array 101, left row decoder 105L, right row decoder 105R, column data register array 104, control block 103, and wire bond pad blocks 1021 (lower) and 102u (upper.) Wire bond pad block 1021 is configured so as to enable contact with an FPCA or other suitable connecting means so as to receive data and control signals over lines from an SLM controller such as that of FIG. 1B. The data and control signal lines for lower wire bond pad block 1021 comprise clock signal line 111, op code signal lines 112, serial input-output signal lines 113, bidirectional temperature signal lines 114, and parallel data signal lines 115. The selected interfaces for upper wire bond pad block 102u comprise circuit voltages V_H 116, emissive pixel current mirror selection signal pads 117 and 118, rail voltages V_{DDAR} and V_{SS} pad 119 and common cathode return (V_Low or V_L) 120. The total number of wire bond pads may easily exceed 100 separate pads and may reach several hundred pads. Some voltage supply pads, such as pads for V_{SS} or V_{DDAR}, may be present in multiple instances. The description of the interfaces as external is not limiting on the inventions disclosed in this application. It is conceived that a controller circuit delivering some or all of those signals may be formed in the same semiconductor substrate as the backplane itself. It is further conceived that the dividing lines between a controller and backplane combination may be moved without affecting this disclosure.

Wire bond pad block 1021 receives connections for emissive pixel state data and control signals and moves these signals to control block 103. Control block 103 receives the emissive pixel state data and routes the data to column data register array 104. Row address information is routed to row decoder left 105L and to row decoder right 105R. In one embodiment, the value of Op Code line 112 determines whether data received on parallel data signal lines 115 is address information indicating the row to which data is to be loaded or data to be loaded to a row. In one embodiment the row address information acts as header, appearing first in a time ordered sequence, to be followed by data for that row. In the context of the present application, the word “address” is most often a noun used to convey the location of the row to be written. The location may be conveyed as an offset from the location (address) of a baseline row or it may be an absolute location of the row to be written. This resembles the manner in which a Random-Access Memory device, such as an SRAM, is written or read. The use of column addressing, also used in Random-Access Memory devices, may be envisioned, but other mechanisms, such as a shift register, are also envisioned. Use of a shift register to enable the writing of data to rows of the array is also envisioned.

Row decoder left 105L and row decoder right 105R are configured to pull the word line for the decoded row high so that data for that row may be transferred from bit line driver elements forming column data register array 104 to the memory circuit elements resident in the pixel circuits of that row of pixel array 251. In one embodiment, row decoder left 105L pulls the word line high for a left half of the display, and row decoder right 105R pulls the word line high for a right half of the display.

The depiction of left and right side row decoder circuits and upper and lower wire bond pad circuits is purely for ease of reference and is not limiting upon the present invention.

FIG. 1B depicts a simplified diagram 180 of display controller interfaces with an array of pixel drive circuits. A display controller comprises static voltage section 181a, signal voltage control section 181b and data memory and logic control section 181c. A first row of pixel drive circuits comprises pixel drive circuit 182a1 and pixel drive circuit 182a2. A second row of pixel drive circuits comprises pixel drive circuit 182b1 and pixel drive circuit 182b2. A third row of pixel drive circuits comprises pixel drive circuit 182c1 and pixel drive circuit 182c2. A first column of pixel drive circuits comprises pixel drive circuit 182a1, pixel drive circuit 182b1 and pixel drive circuit 182c1. A second column of pixel drive circuits comprises pixel drive circuit 182a2, pixel drive circuit 182b2 and pixel drive circuit 182c2. The choice of this number of pixel drive circuits in FIG. 1B is for ease of reference and is not limiting upon this disclosure. Arrays of pixel drive circuits comprising in excess of 1000 rows and 1000 columns are commonplace in products for both display purposes and non-display purposes.

Static voltage section 181a provides a set of voltages required to operate the array of pixel drive circuits, said voltages comprising V_{DDAR}, V_{SS}, upper drive voltage V_H and cathode return voltage V_L loaded onto static voltage distribution bus 183a. Static voltage distribution bus 183a distributes V_{DDAR}, V_H, V_{SS} and V_L to the pixel drive circuits of a first row over conductor 187a, to the pixel drive circuits of a second row over conductor 187b and to the pixel drive circuits of a third row over conductor 187c, wherein each of conductors 187a, 187b and 187c comprises at least one separate conductor for each supplied static voltage.

Signal voltage control section 181b delivers control signals required to operate the array of pixel drive circuits, such as word line (WLINE) high for the selected row, over bus 183b. Signal voltage control 181b delivers signals to signal voltage distribution bus 183b, which in turn delivers the signals to the pixels of a first row over conductor 188a, to the pixels of a second row over conductor 288b and to the pixels of a third row over conductor 188c. Conductors 188a, 188b and 188c each may comprise a plurality of conductors such that each control signal is delivered independently of other control signals. The row on which WLINE is to be held high is selected by a row decoder circuit disclosed in conjunction with the following description of data memory and logic control section 181c Timing of the signal voltages and their application to the circuit are typically controlled by an executive function such as data memory and logic control section 181c. The word line for the selected row is one of conductor 189a, conductor 189b or conductor 189c, as determined by the state of each row decoder set by data memory and logic control section 281c.

Data memory and logic control section 181c performs several functions. It may, for example, translate modulation data received in a standard 8-bit 10-bit or 12-bit format into a form usable to pulse-width modulate a display. A first function is to select a row for data to be written to and a second function is to load the data to be written to that row. Data memory and logic control section 181c loads image data onto column (bit line) drivers 191a and 191b over bus 185. Conductors 184a1 and 184a2 represent a first pair of complementary bit lines that route data to the first column. Conductors 184b1 and 184b2 represent a second pair of complementary bit lines that route data to the second column. Each of said pair of complementary bit lines are operative to transfer data from column drivers 191a or 191b respectively to the memory circuit of each pixel of the selected row. Data memory and logic control section 181c loads the selected address information onto address data bus 183c, which acts to select the correct row using row decoder circuit 190a, row decoder circuit 190b and row decoder circuit 190c each positioned on address data bus 183c. When WLINE for the selected row is held high, the data on the bit line drivers are loaded into the memory circuit of each pixel of the selected row.

Column (bit line) drivers 191a and 191b may each comprise a tri-state buffer and a memory circuit, wherein the memory circuit asserts its output onto the tri-state buffer. The tri-state buffer further comprises an enable terminal and an output. When a signal is received from data memory and logic control section on the enable terminal, the value asserted on the input of the tri-state memory circuit is then asserted onto its output. This provides a measure of control over the loading of data onto the bit lines.

Other needed functions not specifically described here may be provided by the controller/backplane combination described herein.

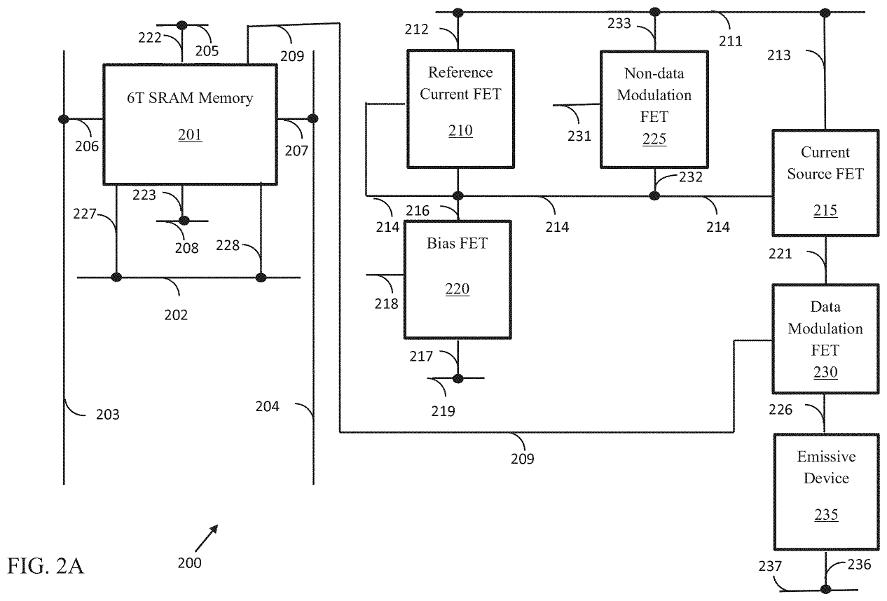

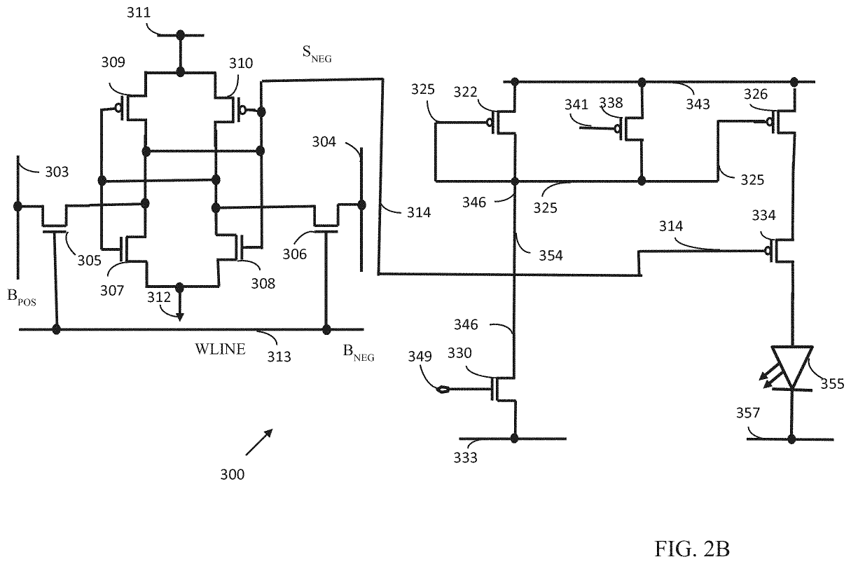

FIG. 2A presents block diagram 200 of a current mirror pixel drive circuit of an array of pixel drive circuits after the present application. Pixel drive circuit 200 comprises SRAM memory circuit 201, a current mirror circuit comprising reference current FET 210, current source FET 215, and bias FET 220, non-data modulation FET 225 operative to shut current source FET 215 off when pulled high and a data modulation FET comprising modulation FET 230 operative to pulse-width modulate the output of the drain of FET 230 in order to impose data gray scale on LED 235 associated with that pixel drive. SRAM memory circuit is depicted as a 6-T (6 transistor) circuit although the use of other SRAM memory circuits with different numbers of transistors is anticipated. Other emissive devices other than LEDs are anticipated.

SRAM memory circuit 201 is connected to word line (WLINE) 202 by conductors 227 and 228. Complementary data lines (Bros) 203 and (B_{NEG}) 202 connect to SRAM memory circuit 201 by conductors 206 and 207 respectively. When WLINE 202 is pulled high, pass transistors in the memory circuit allow new data to be stored in the memory circuit. Data output S_{NEG} of SRAM 201 is asserted over conductor 209 onto the gate of data modulation FET 230. The operation of SRAM 201 and its complementary outputs is well known in the art.

More detail regarding the functions of an SRAM memory circuit are available in many sources. Applicant cites ONG, “Modern MOS Technology; Processes, Devices and Design”, Ong, McGraw-Hill, New York, 1984, pp. 207-208, as a more detailed explanation, the contents whereof are incorporated herein by reference.

Together FETs 210, 215, 220, 225, and 230 form a circuit operative to deliver a pulse-width modulated drive waveform to LED 235 driven by the pulse width modulated waveform at required voltage and current levels. Reference current FET 210 and bias FET 220 together provide a reference current to the gate of current source FET 215 at a required voltage. Reference current FET 210 sets the reference current I_{REF} and Bias FET 220 sets the voltage for the reference current on conductors 214 and 216. Bias FET 220 is a large L FET designed to operate as a variable resister with its resistance determined by a bias voltage V_{BIAS} applied to its gate over conductor 218. In one embodiment, V_{BIAS} is set externally and, in one embodiment, is supplied to all pixel drive circuits. In one embodiment the gate of BIAS FET 220 is connected to V_{SS}. The source of bias FET 220 is connected to conductor 219 by conductor 217. Conductor 219 is connected to voltage V_{SS}. In one embodiment, the stable reference current asserted onto conductor 214 is supplied to a plurality of pixel drive circuits. In one embodiment, the stable reference current is asserted onto the gate of its own current source FET 215 and onto the gates of local pixel drive circuits forming a sub-block or block of pixel drive circuits.

Current source FET 215 is operative to receive a stable reference current at its gate over conductor 240 and mirror that current. The source of FET 215 is connected over conductor 213 to conductor 211, which supplies voltage V_H. The drain of current source FET 215 asserts a stable current over conductor 221, wherein the stable current may differ from the reference current. To achieve the desired current at the drain of FET 215, current source FET 215 must be dimensioned to achieve that. FET 215 is preferably designed so that the relationship between the length (L) and the width (W) is selected in order to achieve the desired current at its drain. The desired current asserted on the drain of FET 215 may differ from the reference current received on the gate of FET 215, depending on the design W/L ratio of FET 215.

Non-data modulation FET 225 acts to modulate the output of current source FET 215 to achieve a desired maximum brightness level. The gate of non-data modulation FET 225 receives a signal l_off from an external modulation element. The source of FET 225 is connected to conductor 211 by conductor 233, which asserts V_H onto the source of FET 225. If l_off is low then FET asserts V_H minus a small threshold voltage onto its drain, whereupon the substantially V_H voltage acts upon the gate of current source FET 215 to take current source FET 215 out of saturation mode. This results in FET 215 no longer acting as a current source. This enable signal l_off to act as a form of non-data modulation control signal. The action of l_off is to raise or lower the overall duty cycle of the modulation output of pixel drive circuit 200, thereby controlling its intensity without regard for the data state of the SRAM circuit.

Data modulation FET 230 responds to pulse-width modulation waveforms used to create gray scale modulation. The need to perform this function is well known in the art. The output of the drain of FET 215 is asserted onto the source of modulation FET 230 over conductor 221. The gate of data modulation FET 230 is connected to output S_{NEG} of SRAM 201 over conductor 209. When the data state of SRAM 201 is on, then S_{NEG} is low and acts on the gate of data modulation FET 230 to enable it to assert the current asserted onto its source over conductor 221 onto its drain over conductor 226.

The output of the drain of data modulation FET 230 is asserted onto conductor 226. The output comprises a pulse width modulated signal operative to create a gray scale modulation at a desired intensity. The output is connected over conductor 226 to the anode of an emissive device such as LED 235. The cathode of emissive device 235 is connected by terminal 236 to V_L asserted onto conductor 237. The voltage level of V_L is lower than V_H and may be lower than V_{SS} and may be a negative voltage.

In order to avoid aliasing caused by the operating rate of 1_off should create pulse intervals that is shorter than the shortest pulse duration imposed on S_neg by a substantial margin, perhaps a factor of 10 to 1 in order to avoid aliasing. In some non-display applications, the issue of aliasing may be less important. In that case the pulse interval of l_off may correspond to tens or more of lsb intervals. In one embodiment operation of l_off is synchronized with operation of S_{NEG}.

FIG. 2B presents an emissive pixel drive circuit similar to the pixel drive circuit presented in FIG. 2A. The emissive pixel drive circuit comprises a memory circuit comprising FETs 305, 306, 307, 308, 309 and 310, a current and modulation section comprising FETs 322, 338 and 326 and a large L n-channel bias circuit comprising bias FET 330. In the present invention all pixel drive circuits comprise a memory circuit comprising FETs 305, 306, 307, 308, 309 and 310 and a current and modulation section FETs 322, 338, and 326. Some pixel drive circuits share an instance of the bias circuit with at least one other pixel drive circuit, wherein the at least one other pixel drive circuit comprises a memory circuit and a current and modulation section and wherein the at least one other pixel drive circuit is contiguous to the pixel drive circuit containing the shared large L n-channel bias FET. Some pixel drive circuits may comprise only a memory circuit 300 and a current and modulation section, while sharing a large L n-channel bias FET placed in an adjacent pixel circuit. In one embodiment, all pixel drive circuits of a block of pixel drive circuits share a single large L n-channel bias FET modeled after bias FET 330. In one embodiment, a single bias FET is shared across current mirror circuits in different sub-blocks. Those of skill in the art will recognize that the p-channel FETs and n-channel FET functions can be reversed. The reversal of functions is considered to be within the bounds of the present disclosure.

The memory circuit is a 6-transistor static random access memory (SRAM). The memory circuit comprises pass transistors 305 and 306 operative to simultaneously turn on when the voltage on word line 313 is pulled high by a row select circuit (not shown.) P-channel FET 309 and n-channel FET 307 form a first inverter and p-channel FET 310 and n-channel FET 308 form a second inverter. Complementary image data is loaded onto bit line 303 (Bros) and onto bit line 304 (B_{NEG}). When pass transistor 305 is turned on by a voltage applied to WLINE 313, the data loaded onto bit line 303 is asserted onto the drain of p-channel FET 309 and the drain of n-channel FET 307 and onto the gates of p-channel FET 310 and n-channel FET 308. Similarly, when pass transistor 306 is turned on by a voltage applied to WLINE 313, the data loaded onto bit line 304 is asserted onto the drain of p-channel FET 310 and the drain of n-channel FET 308 and onto the gates of p-channel FET 309 and n-channel FET 307.

The sources of p-channel FETs 309 and 310 are connected to V_{DDAR} (V_{DD} array) over conductor 311 and the sources of n-channel FETs 307 and 309 are connect to V_{SS} (ground) over conductor 312.

Noting that the data on bit line 303 is complementary to the data on bit line 304, the line that hold the 0 data at the lower voltage is more effective at changing the state of the memory circuit. The inverse of the resulting state of the memory circuit asserted onto data signal conductor 314 (S_{NEG}). Specifically, if the data state of the memory circuit is high, then the output on conductor 314 is low and vice versa.

More detail regarding the functions of an SRAM memory circuit is available in many sources. Applicant cites previously cited ONG, “Modern MOS Technology; Processes, Devices and Design”, Ong, McGraw-Hill, New York, 1984, pp. 207-208, as a more detailed explanation, the contents whereof are incorporated herein by reference.

The current and modulation section comprises p-channel FET 322 and p-channel FET 326, forming a reference current/current source pair, p-channel non-date modulation FET 338 operative to impose a non-data driven modulation on the current and modulation section and p-channel data modulation FET 334 operative to impose a data driven modulation on the output of the current and modulation section.

Current and modulation circuit receives the output of the memory circuit over data signal conductor 314 and uses this to modulate the current generated in the current and modulation circuit. P-channel reference current FET 322 and p-channel current source FET 326 form a current mirror circuit. The voltage bias level of reference current FET 322 is set by the bias circuit wherein the drain of large L n-channel bias FET 330 is connected to the gate and drain of p-channel reference current FET 322 over conductors 346 and 325. The source of large L n-channel FET 330 is connected to V_{SS} over conductor 333. The source of p-channel reference current FET 322 is connected to a global supply voltage V_H asserted on conductor 343. The value of V_H is independent of V_{DDAR} and is selected so that the correct operating voltage is asserted onto the anode of emissive device 355 in conjunction with a second global voltage V_L asserted onto its cathode over conductor 357 as explained below. The source of p-channel current source FET 326 is also connected to global voltage V_H asserted on conductor 343.

Current source FET 326 mirrors the reference current generated by reference current FET 322. As is well known in the art, the current from current source FET 326 may be the same as the current from reference current FET 322 or may greater or less depending on differences in the ratio of width to length between the physical instances of reference current FET 322 and current source FET 326. The W/L ratio of current source FET 326 may be scaled up or down relative to the W/L ratio of reference current FET 322 to either scale the current down or up. Those of skill in the art will recognize that for a given conductor material, length and thickness, an increase in width will reduce the resistance.

Modulation FET 538 receives modulation signal l_off over terminal 341 on its gate. L_off is a non-data dependent signal used to impose a duty cycle modulation on an emissive pixel drive circuits. L_off may be used to cause a dimming of any emissive pixel drive circuits in an on state. Modulation FET 338 is parallel to current source FET 326. When 1_off is held low, modulation FET 338 is placed in an on state and pulls the voltage asserted on the gate of current source FET 326 effectively to the same voltage as its source, thereby effectively shutting off the current mirror function which in turn effectively reduces the current to zero. This in turn shuts off emissive device 355.

The current output on the drain of current source FET 326 is asserted on the source of p-channel data modulation FET 334. As a p-channel device, FET 334 will assert the signal on its source onto its drain (minus a threshold voltage) when the signal asserted on its gate is low. The signal asserted on the gate of 334 is S_{NEG}, which is the complement of its data state of the memory circuit, as previously noted. The drain of FET 334 is asserted onto the anode of emissive device 355. The apparent brightness of emissive device 355 will depend on the magnitude of the current asserted on its anode integrated over time. An increase in off time due to the actions of FET 338 and FET 334 will reduce the apparent brightness of the emissive device. The cathode of emissive device 355 is connected to a global voltage V_L asserted onto conductor 357, wherein V_L is independent of rail voltages V_{DDAR} and V_{SS}. In one embodiment all cathodes are connected to the same global voltage V_L in a common cathode arrangement. In one embodiment, V_L is equal to V_{SS}.

The bias circuit comprises large L bias n-channel FET 330 and connections to other circuit elements. The source of large L n-channel bias FET 330 is connected to V_{SS}. The gate of bias FET 330 is connected to a bias reference voltage V_{BIAS} supplied from a source external to the pixel drive circuit over terminal 349. In one embodiment, V_{BIAS} is supplied by a temperature stabilizing device operative to adjust V_{BIAS} in response to changing temperature to ensure that the current from the current mirror does not vary beyond a small amount as a function of temperature.

All active pixel drive circuits must have a biasing circuit as described. Not all pixel drive circuits may be required to be active in a particular instance of an array of pixel drive circuits formed from individual pixel drive circuits such as that of FIG. 2B. In those instances where the underlying pixel drive circuit is not to be connected to an emissive device through a metal layer, the source and drain of large L n-channel FET 330 may be connected to ground.

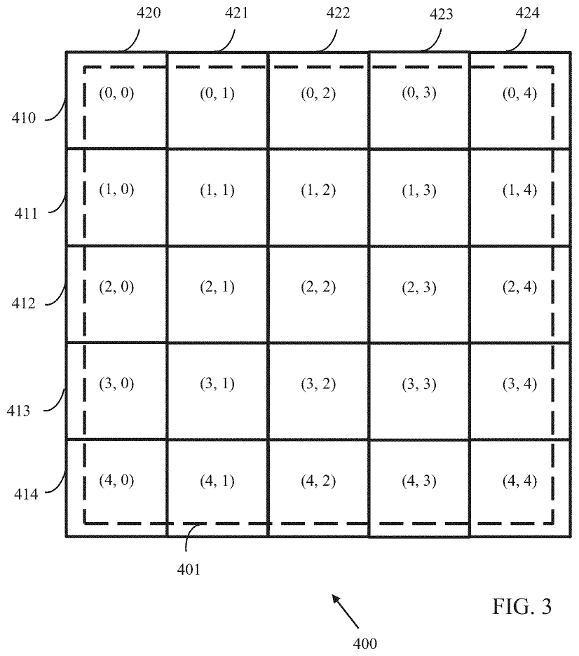

FIG. 3 presents a diagram representing a 5 rows by 5 columns array of pixel drive circuits forming block 400 of pixel drive circuits surmounted by a common electrode 401 to which each of the 25 pixel drive circuits is electrically connected. The pixel drive circuits may be circuits similar to those described in this application or others known in the art. The invention is not limited to 5 by 5 blocks of pixel drive circuits and may conceivably be between 4 and 8 columns and between 4 and 8 rows. These are not limiting on this invention and future circuits may comprise more or fewer row and columns than the range described.

Each square represents the footprint of a pixel drive circuit. The coordinates for each pixel drive circuit is represented by a number in parentheses in the form (x, y) where the first numeral represents the row and the second numeral represents the column in which the pixel drive circuit is found. Thus column 420 is the 0^{th} column, 421 is the 1^{st} column and so forth till column 424 is the 4^{th} column. In like manner, row 410 is the 0^{th} row, row 411 is the 1^{st} row and so forth till row 414 is the 4^{th} row.

The physical layout of the pixel drive circuits may differ by position within the block of pixel drive circuits even if the pixel drive circuits are schematically identical. Some designers choose to make repetitive circuit designs such as pixel drive circuits into block of four wherein a first circuit such as, for example, the one at position (0, 0) of block of pixel drive circuits 400 is mirror about a vertical axis onto position (0, 1) and about a horizontal axis onto position (1, 0). The mirrored circuit at (1, 0) can then be mirrored about a vertical axis onto position (1, 1) The double mirrored circuit at position (1, 1) is also a mirror of the circuit at position (0, 1) about a horizontal axis.

A word line crossing several blocks of pixel drive circuits at the same row position within each of the blocks of pixel drive circuits will control a similar set of memory circuits on each row. The order of the memory circuits is only important to the extent that the memory circuits control pixel drive circuits of differing current weightings. If all pixel drive circuits are of identical current weightings, then the order is unimportant because each can stand in for another pixel drive circuit even in the mirror configuration described above. Appropriate data must be loaded to the column drivers to be placed on the bit lines.

In a first physical embodiment, the backplane for an array of emissive devices is formed from a plurality of rows and plurality of columns of blocks of pixel drive circuits after block 400. Each is surmounted by a common electrode 401 to which the anode of an emissive device is attached as previously described. Each pixel drive circuit comprises a memory circuit suitable for applying data based modulation to the output of the pixel drive circuit and the current output of each pixel drive circuit is equal to the current output of all other pixel drive circuits. The pixel drive circuits in a row spanning a plurality of blocks of pixel drive circuits are organized for row write actions as described for FIG. 1A and FIG. 1B. The function of a vertical stack of blocks (at least a plurality) may be organized logically using the row decoder methods previously described without having to resort to hard wired blocks, although either approach is feasible. The row decoder method is more flexible.

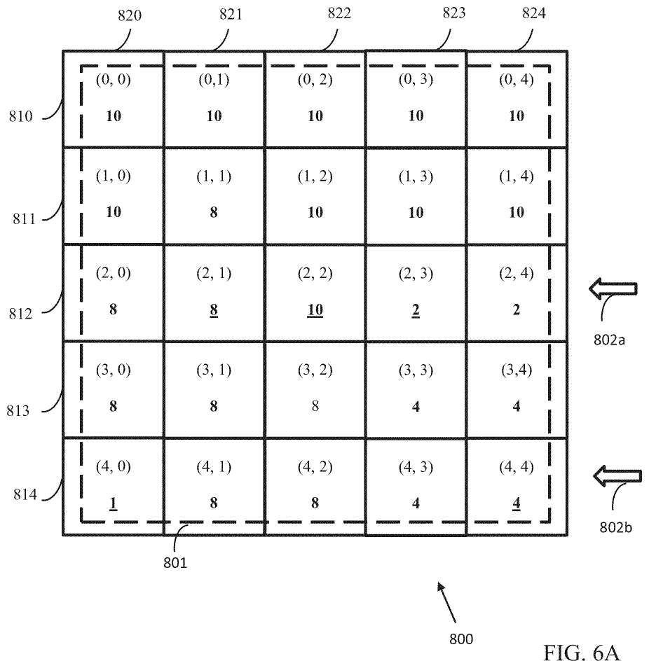

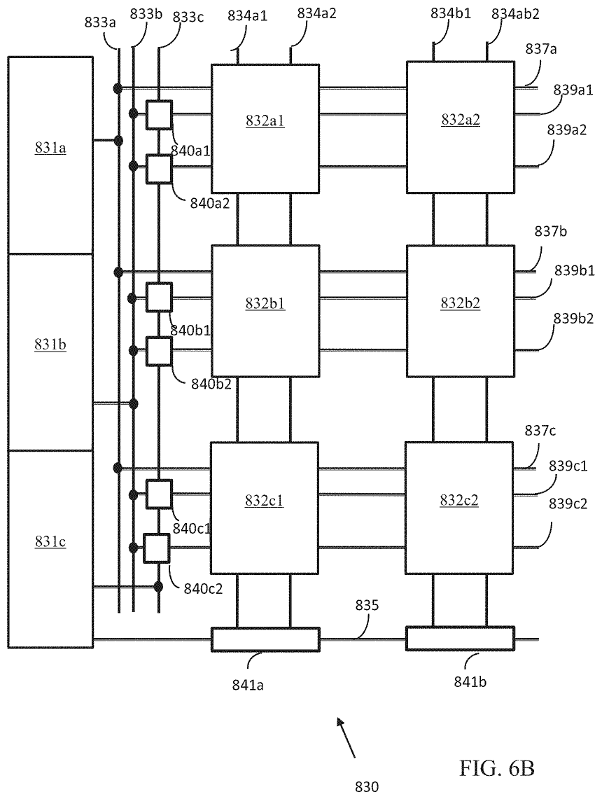

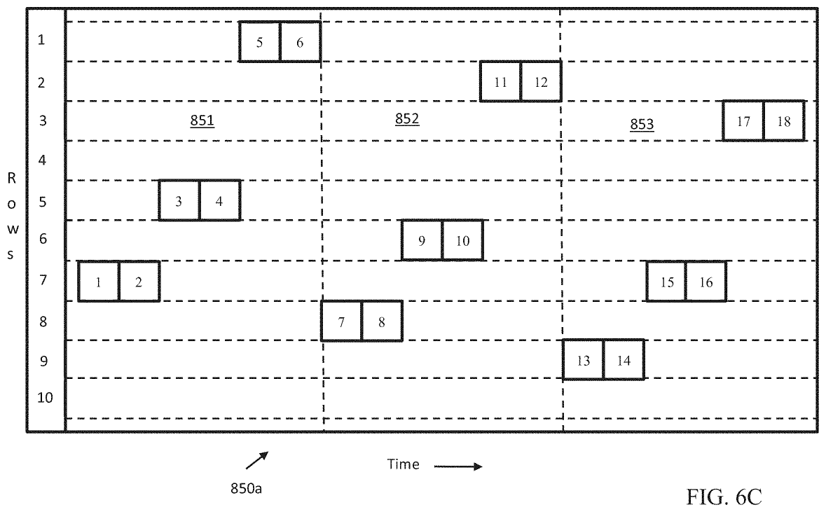

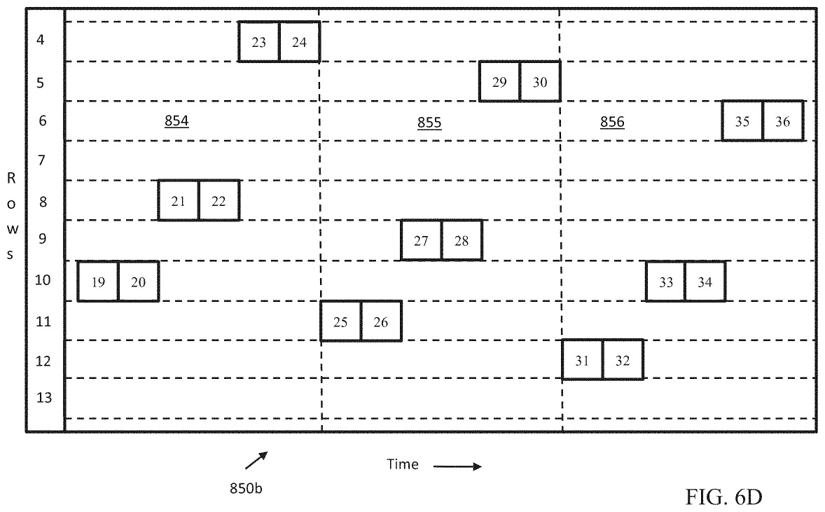

The first physical embodiment may be pulse width modulated in a number of ways. In a first manner, the entire array of pixel drive circuits may be modulated by a single top to bottom scan. This can be visualized as moving from the top to the bottom of the pixel drive circuit array 101 of SLM 100 of FIG. 1A. Reference is made to U.S. patent application Ser. No. 10/435,427, now U.S. Pat. No. 8,421,828, FIGS. 6A and 6B, which demonstrate this modulation method and which is incorporated herein by reference in its entirety. Continuations of U.S. patent application Ser. No. 10/435,427, U.S. patent application Ser. No. 13/790,129, now U.S. Pat. No. 9,583,031, and U.S. patent application Ser. No. 15/408,860, now U.S. Pat. No. 9,824,618 of U.S. patent application Ser. No. 10/435,427, are also incorporated herein by reference. This will provide complete modulation data to each block of pixel drive circuits on a given row of blocks in five full width row write cycles. If the desire is only to keep maintain the LED at a given current level selected by the choice of on and off states then 26 levels are possible—completely off and 25 different on states by counting the number of on state pixel drive circuits. This is less than 5 bit modulation depth (2⁵=32). For headlamp applications a requirement of 10 bit modulation depth (1024 levels) is often referred to. Therefore, some improvement is required.

In an improvement to the previous modulation method, a level of temporal pulse width modulation is implemented. For the 5 by 5 block of pixel drive circuits, the gray scale range can be expanded to 10 bits by using pulse width modulation of short duration on one pixel drive circuit and setting enough of the other pixel drive circuits to on without modulation pulse width of short duration at the same time. Forty one write pointers are required to create the number of intermediate pulse width modulation steps needed for the combination of the one pulse width modulated pixel drive circuit and the other 24 pixel drive circuits to reach 10 bits modulation depth by providing 1025 distinct on states and one off state. The other pixel drive circuits may be changed at the end of the 41 write pointer sequence.

As a first example of this modulation example, assume that the order for fully turned on pixel drive circuits begins at (0, 0) and then moves across the row to (0, 4) after which it proceeds across the next row beginning at (1, 0) and so forth until pixel drive circuit (4, 4) is reached and turned fully on. In the first step for pixel drive circuit (0, 0) to go from 0 to 41, based on 41 consecutive write pointers, each operated from top to bottom of the entire array of blocks of pixel drive circuits.

To generate a current proportional to a gray level of 1 out of 1025, in a first pass of a write pointer on pixel drive circuit (0, 0), pixel drive circuit (0, 0) is turned on and on a second pass it is turned off and remains off until all 41 write pointers have been written. To generate a current proportional to a gray level of 2 out of 1025, in a first pass of a write pointer on pixel drive circuit (0, 0), that pixel drive circuit is turned on and in a second pass of a write pointer that pixel drive circuit is left on. In a third pass of a write pointer, pixel drive circuit (0, 0) is turned off and left off until all 41 write pointers have been written. To generate a current proportional to a gray level of 40 out of 1025, pixel drive circuit (0, 0) is turned on and left on by subsequent write pointer actions until the 41″ write pointer turns pixel drive circuit (0, 0) off. Although the on state time intervals are described as being adjacent temporally, there is no requirement that they be adjacent temporally and in fact the on state time intervals may be dispersed to any degree necessary.

To generate a current proportional to 41 out of 1025, pixel drive circuit (0, 0) is turned on and left on for subsequent write pointers through the 41″ write pointer action. At this point, pixel drive circuit (0, 0) is fully on. From this state there are at least two alternative paths that may be followed.

In a first path, pixel drive circuit (0, 0) is left on and another pixel drive circuit such as (0, 1) is now pulse width modulated. The operation of pixel drive circuit (0, 1) will follow the same process previously described for pixel drive circuit (0, 0). As an example, to generate a current proportional to 45 out of 1025, pixel drive circuit (0, 0) is left on by all write pointer actions and pixel drive circuit (0, 1) is turned on by the first write pointer actions, left on by the second, third and fourth write pointer actions, and then is turned off by the fifth write pointer action. The choice of the number of write pointers x applied to pixel drive circuit (0, 1) is x=45−41=4.

This approach can be generalized to an equation of the form y=nx+b, wherein y is the desired intensity level based on current, n is the total number of write pointers in the sequence, x is the number of fully on state pixel drive circuits needed, and b is the number of on state write pointers needed to reach intensity level y using the pulse width modulated pixel drive circuit. The calculation of the values for n and b can be described in the terminology of long division as practices in the United States and many other English speaking nations. Simply put, dividing y (numerator) by x (divisor) and taking n as the integer quotient and b as the remainder.

Operating a block of pixel drive circuits on a backplane in the manner described has one particular benefit. The intensity of an emissive device driven in this manner will increase monotonically with increasing intensity number because each intensity number will have all the intensity time intervals of the next lower intensity number with one additional time interval of current added in. This does not mean that the intensity curve is fully linear because variances in the performance of the individual pixel drive circuits is possible due to such things as variances in threshold voltages and the like.

In a second path to pulse width modulation, the same approach to pulse width modulation is taken. However, a single pixel drive circuit in the block of pixel drive circuits is always the circuit that is pulse width modulated. The remaining pixel drive circuits are turned on one at a time after a full run of write pointer actions has been completed. This offers an advantage in that a sophisticated controller can reduce the time required to write the entire array because most write pointer intervals only require that the rows with the single pulse width modulated pixel drive circuit be written. There is a discrepancy in the time required to write the entire array of blocks of pixel drive circuits that can be at least partially compensated for by designing the single pulse width modulated pixel drive circuits to yield higher current per time interval.

A disadvantage of this approach is that it is not guaranteed to be monotonic. This results from the previously mentioned variances in threshold voltages and the like. If the current generated by the single pulse width modulated pixel drive circuit in the block of pixel drive circuits generates more current when fully on than one of the pixel drive circuits then a non-monotonic step is assured when the pulse width modulated pixel drive circuit steps from its fully on state and the pixel drive circuit that has lesser current drive is switched on in its place.

In a third path to pulse width modulation, the approach of the second path is expanded to allow pulse width modulation of a plurality of pixel drive circuits in the block of pixel drive circuits. Using this approach, the overall brightness can be reduced in a manner similar to the second path above. The advantage is not in the production of current but rather in a dispersion of any attendant heating.

In one embodiment the individual drive circuits of block of pixel drive circuits 400 of FIG. 3 comprise a variety of current strengths. For example, one grouping may be 0.75 each compared to a second grouping at 1.00 each and a third grouping at 1.25 each, al relative current strengths. These values can be used to assemble a modulation sequence that approximates a linear modulation sequence. The provided example is not limiting on the invention.

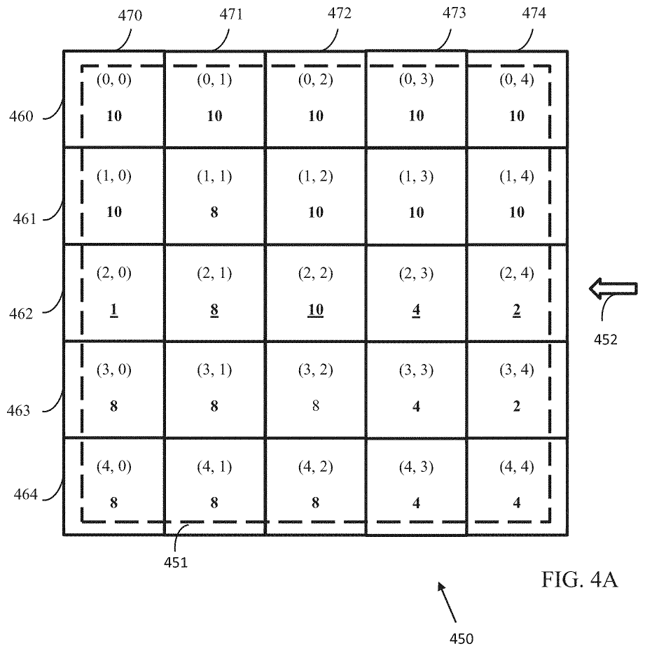

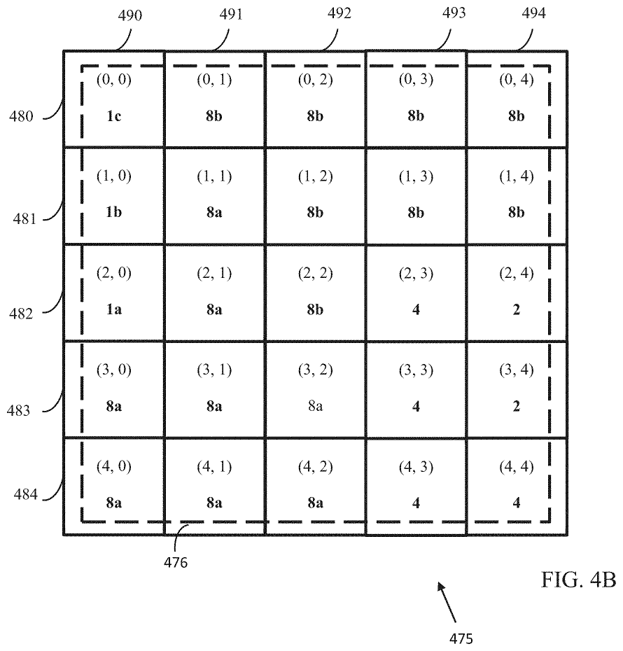

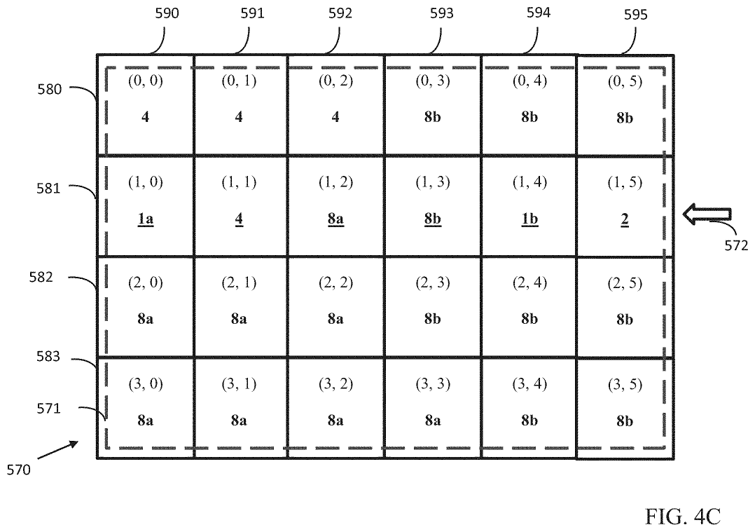

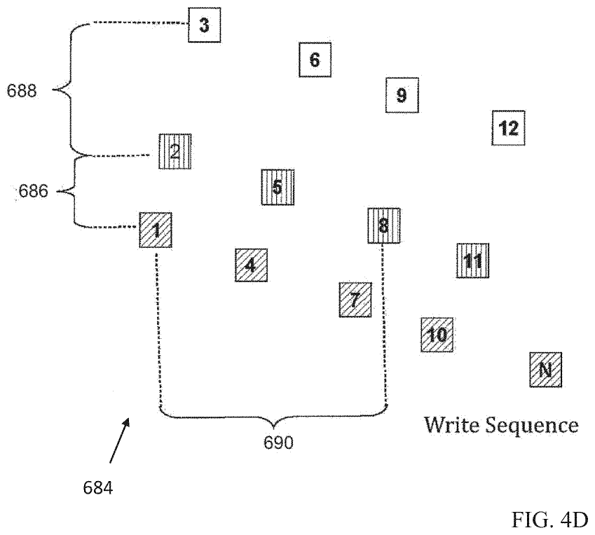

FIG. 4A depicts a method of achieving binary weighted modulation of a block of pixel drive circuits 450 through either logical or physical sub-blocks. The pixel drive circuit coordinate system described for FIG. 3 is used for 4A and FIG. 4B and is extended for FIG. 4C. Block of pixel drive circuits 450 is surmounted by a conductive pad 451 on which the anode of an emissive device such as an LED may be mounted electrically and physically.

In a first implementation, block of pixel drive circuits 450 is logically organized as shown. A single bit of current modulation is provided by pixel drive circuit (2, 0), two bits of current modulation are provided by pixel drive circuits (2, 4) and (3, 4), four bits of current modulation are provided by pixel drive circuits (2, 3), (3, 3), (4, 3), and (4, 4) and 8 bits of current modulation are provided by pixel drive circuits (1,1), (2, 1), (3, 0), (3, 1), (3, 2), (4, 0), (4, 1) and (4, 2). The remaining pixel drive circuits (0, 0), (0, 1), (0, 2), (0, 3), (0, 4), (1, 0), (1, 2), (1, 3), (1, 4), and (2, 2) are allocated to a non-binary weighted 10 bits of current modulation depth.

This is an artifact of the total number of pixel drive circuits in block 450. A fully binary weighted block operative to provide 32 levels of modulation could be conceived of as comprising 31 individual pixel drive circuits organized into 16, 8, 4, 2 and 1 bit segments. The on states range from 0 on (full off) to 31 on (full bright.) Since 31 is a prime number there is no block of pixel drive circuits capable of providing that number in anything other than a 1×31 array, which is of low utility. A 32 pixel drive circuit array could be organized into a 4 by 8 block of pixel drive circuits with an extra 1 bit segment beyond the 31 individual pixel drive circuits as previously organized. When that is done, the extra 1 bit segment may be used as a dedicated pulse width modulation circuit operated as previously described for block of pixel drive circuit 400 of FIG. 3.

The use of 5 by 5 block of pixel drive circuits 450 may provide unmodulated current at approximately 4½ bits. (26 gray levels falls between 2⁴=16 and 2⁵=32.) This does not meet the 10 bit modulation depth previously noted as ideal but may be sufficient for some applications. A dedicated pulse width modulation circuit could be used to add the intermediate gray scale steps. This could be done using one pixel drive circuit of the 5 by 5 block of pixel drive circuits for pulse width modulation as previously described and would result in the 1025 different on state illumination levels and one off state previously disclosed.

The use of the convention of assigning positions in block of pixel circuits 450 to specific gray levels simplifies the lookup process to be used. A desired current level specified in terms of the 25 levels that the block of pixel drive circuits is directly capable of providing can quickly be translated into a selection from the 5 sets of current levels a block of pixel drive circuits can provide. The pixel drive circuits assigned to one gray level within the block of pixel drive circuits are depicted as contiguous, but that is not a precondition since each of the 25 pixel drive circuits may be operated through the writing of data to its memory circuit without being contiguous to other pixel drive circuits forming a part of the same gray level.

In a second implementation, the pixel drive circuits assigned to each current level (and therefore gray level) are electrically synchronized. The mechanism by which the pixel drive circuits are placed in the on or off state may be through the use of a single memory circuit to control the data state of all pixel drive circuits assigned to a given current level. Alternatively the use of a current mirror circuit with a plurality of current source FETs designed to the required current levels may be used. The required physical footprint may vary from the rectilinear description, although the spacing of the memory elements will be dictated by the design of the horizontal word lines and associated drivers and the vertical bit lines and associated drivers.

Use of a single memory circuit to determine the state of a sub-block of pixel drive circuits can be made most efficiently if the memory circuits of all of the sub-blocks can be aligned in the same row so that only one word line is required to address all of the memory circuits of the various sub-blocks of the same block. Alternatively, the memory circuits may appear in separate rows but are electrically arranged so that only one word line is required for all memory circuits to be placed in a state to receive data over bit lines. For block of pixel drive circuits 450, all memory circuits may be placed in row 462, indicated by pointer 452. This will reduce the number of row write actions required to address the memory circuits of a block of pixel drive circuits from 5 to 1. A natural corollary to this is that the memory circuit of a sub-block of pixel drive circuits must not share bit lines with any of the memory circuits of the other sub-blocks of pixel drive circuits.

The reduction of the number of row write actions to just one for each block also enables the use of previously cited U.S. patent application Ser. No. 10/435,427, now U.S. Pat. No. 8,421,828, and its previously cited continuations U.S. patent application Ser. No. 13/790,120, now U.S. Pat. No. 9,583,031, and U.S. patent application Ser. No. 15/408,869, now U.S. Pat. No. 9,824,619, without modification. Each word line action will address the memory state of all sub-blocks of pixel drive circuits within a block of pixel drive circuits, as previously described. An example of the same modulation method modified to allow modulation of a block of pixel drive circuits requiring most than one word line is provided herein.

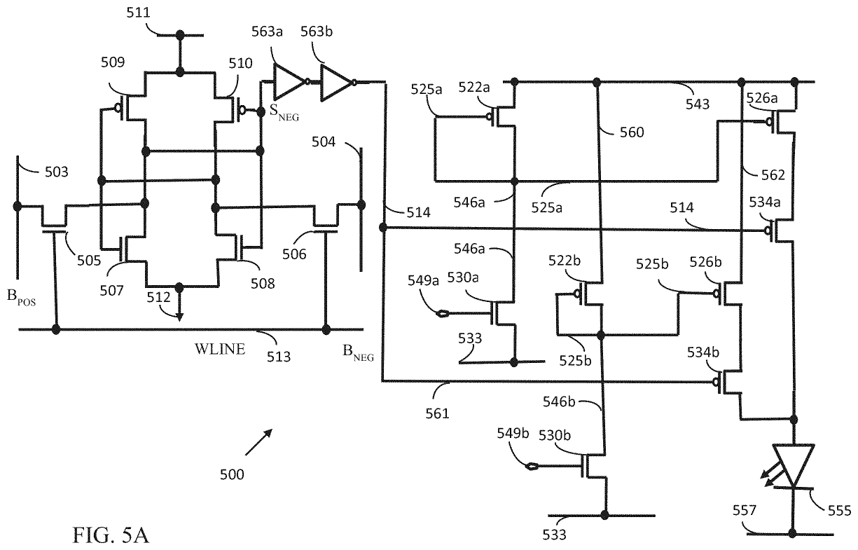

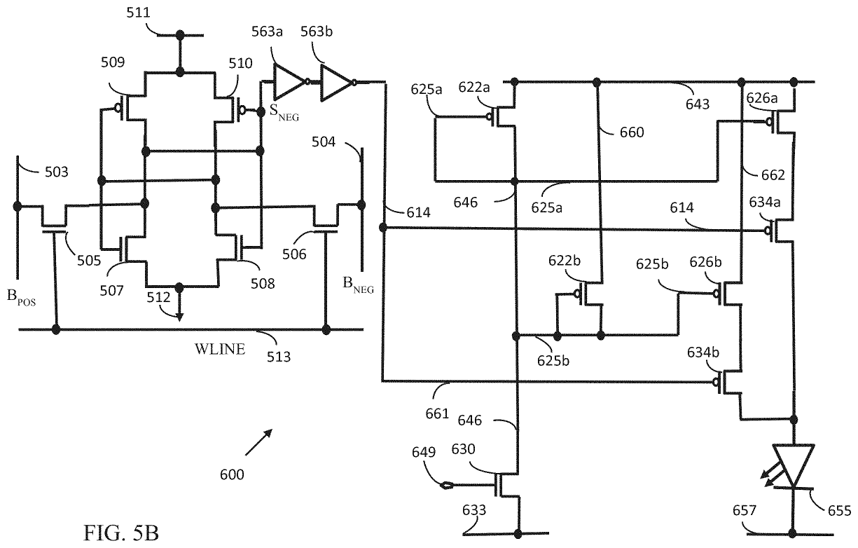

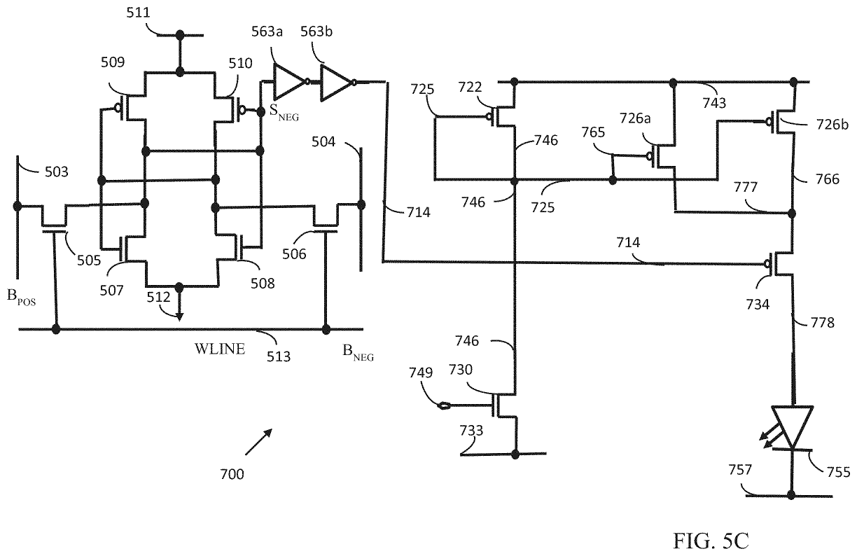

Controlling more than one pixel drive circuit from a single memory circuit may require some special design to avoid loading time delays due to loading on the memory circuit. This loading induce delay can be avoided to a degree through careful design. However, there may be instances where buffering circuitry may be needed. A double buffer comprising two inverter circuits in series is a possible solution. A circuit diagram 500 comprising two pixel drive circuits sharing a common memory circuit is presented in FIG. 5A.

FIG. 4B depicts an alternative method of achieving binary weighted modulation of a block of pixel drive circuits 475 through either logical or physical groupings. Block of pixel drive circuits 475 is surmounted by a conductive pad 476 on which the anode of an emissive device such as an LED may be mounted electrically and physically.

The basic structure described for FIG. 4A is retained here with some modifications. The rows are number 480 through 484 and the columns are numbered 490 through 494. The internal pixel drive circuit coordinates remain (0, 0) through (4, 4). Now the pixel drive circuits are organized into three sub-blocks of one pixel drive circuit each identified as 1a, 1b and 1c, one sub-block of two pixel drive circuits identified as 2, one sub-block of four pixel drive circuits identified as 4, and two sub-blocks of eight pixel drive circuits identified as 8a and 8b.

The two sub-blocks of eight pixel drive circuits identified as 8a and 8b may be operated as thermometer bits as described in previously referenced patent application Ser. No. 10/435,427, and its continuations. In brief, when the sum of the on state of sub-blocks of pixel drive circuits 1a (or 1b or 1c), 2, and 4 (the lesser bits) increments by one from 7 to 8, then sub-block of pixel drive circuits 8a (or 8b) is turned on and sub-blocks of pixel drive circuits 1a, 2 and 4 are turned off. Then the turning on of the lesser binary weighted sub-blocks of pixels can begin again. Once the lesser bits are at 7 (1a, 2 and 4 on) and the increment of one is added, now the other of sub-block of pixel circuits 8a or 8b can be turned on so that both sub-blocks of pixel circuits 8a and 8b are on and lesser sub-blocks of pixel circuits are off. From there the lesser sub-blocks of pixel circuits are turned on until 1a, 2 and 4 are all on. To completely turn on all the pixel drive circuits of all sub-blocks, sub-block of pixel drive circuits 1b and sub-block of pixel drive circuits 1c may be turned on.

To achieve a greater range of gray scale steps, the 41 write pointer sequence previously mentioned with regard to block of pixel circuits 400 of FIG. 3 may be applied to one of sub-block of pixel drive circuits 1b or 1c. The description of FIG. 3 is not repeated here but the applicability of the method described in particular with respect to the second path to pulse width modulate one pixel drive circuit of the block of pixel drive circuits found in the text regarding FIG. 3.

One deficiency of the block of pixel drive circuit 475 of FIG. 4B is that it is not possible to place the memory circuit of each sub-block of pixel drive circuits on the same row. The width of each row of the block is 5 pixel drive circuits and there are 7 blocks. FIG. 4C depicts a block of pixel drive circuits 570 organized into an arrangement with 6 columns and 4 rows of pixel drive circuits for a total of 24. A conductive pad 571 to which a single emissive device may be connected is positioned over the block of pixel drive circuits 570. The rows are number 580 through 583 and the columns are numbered 590 through 595. The coordinates inside each box represent the row and column designation for each pixel drive circuit. The sub-blocks forming each of the binary weighted current sources are identified as 1a, 1b, 2, 4, 8a and 8b.

The operation of the sub-blocks to provide gray scale follows the method disclosed for FIG. 4B and is not repeated here. One difference is that all sub-blocks have a member of the sub-block positioned on row 581 as indicated by arrow 572. This enables the entire block of pixel drive circuits to be operated with all memory elements confined to row 581, as previously described for block of pixel drive circuits 450 in FIG. 4A. If the block of pixel drive circuits needs to be more square than rectangular, then the individual pixel drive circuits can be designed to a more rectangular shape with the width roughly ⅔ that of the height, provided the column driver design permits this. Again, all memory circuits need to be resident on different bit lines.

FIG. 4D depicts a method of pulse width modulating an array of blocks of pixel drive circuits wherein only one word line action is required to address all the memory circuits of each row of blocks of pixel drive circuits. Modulation sequence 684 is adapted from FIG. 8B of U.S. Pat. No. 8,421,828 with only a minor renumbering difference. The key features are summarized here.

The numbered boxes represent a series of row write actions with the number indicating the time ordered position of each row write action. The boxes with diagonal hashing indicate that the row write action is the first in a set of three row write actions that together form a repeating pattern. The boxes with vertical hashing are the second row write action in the sequence and are placed two rows above the first action in the sequence, as indicated by row interval 686 marked along the left edge of modulation sequence 684. The boxes without hashing represent the third row write action in the sequence and are placed four rows above the second row write action in the sequence, as indicated by row interval 688.

Row write action 4 appears in a box with diagonal hashing that is one row below the starting point of the previous instance of the sequence in the diagonally hashed box 1. Row write actions 4, 5 and 6 maintain the same row spacing between the rows they act on, as do row write actions 7, 8, and 9, offset by one further row, and row write action 10, 11 and 12, which maintain a further one row offset from the previous pattern. Row write action N is a further row write action at some indeterminate point in time, shown as one row offset from row write action 10.

The result of using a pattern applied in this manner, is that eventually a row written by a row write action in the sequence is subsequently overwritten by another row write action at a later point in the sequence. In this instance the row written by row write action 1 is subsequently overwritten by row write action 8. The number of time intervals, as indicated by time interval 690. Time interval 690 corresponds to 7 time intervals from the beginning of row write action 1 to the beginning of row write action 8. A similar occurrence exists between row write action 4 and row write action 11.

The scale of modulation sequence 684 does not permit a full display of a second row write action that encompasses the four row spacing between row write actions 2 and 3, but by inspection a row write action 15 (not shown) would overwrite the data written by row write action 2, which would correspond to 13 time intervals. This is not precisely linear but it is sufficient to allow pulse width modulation to be implemented in a reasonable fashion. Because changes to the number of current sources that are added to brightness can induce a first type of intensity modulation, the addition of a pulse width modulation scheme can be sued to further add to the number of gray scale values available.

Prior art applications of this pulse width modulation method have been applied either to emissive devices of constant luminance, thereby varying the apparent luminance, or to liquid crystal devices modulated between a high and a low voltage potential, thereby modulating the intensity of the light modulated by the liquid crystal device. Both mechanisms have been used successfully. The present proposed use where the intensity of the luminance is already subject to variation by other means has not been previously demonstrated.

FIG. 5A presents emissive pixel circuit 500 that depicts a pixel drive circuit as previously disclosed for FIGS. 4A, 4B and 4C. The emissive pixel drive circuit comprises a memory circuit comprising FETs 505, 506, 507, 508, 509 and 510, a first current and modulation section comprising FETs 522a and 526a and a bias circuit comprising bias FET 530a and a second current and modulation section comprising FETs 522b and 526b and a bias circuit comprising large L n-channel bias FET 530b. The S_{NEG} output of the SRAM memory circuit is asserted onto the input of an optional non-inverting buffer comprising inverters 563a and 563b, which are arranged in series. The output of the non-inverting buffer is asserted onto the gates of modulation FET 534a and modulation FET 534b. The non-inverting buffer serves to isolate the SRAM current from the effects of loading due to the connection multiple parallel modulation FETs. The present invention is not limited to two inverters in series as additional inverters may be added as needed. The number of inverters need not be limited to an even number as an odd number can be used if the signal S_{POS} is used rather than S_{NEG}. Those of skill in the art will recognize that the p-channel FETs and n-channel FET functions can be reversed and such a reversal of functions is considered to be within the bounds of the present disclosure.

The memory circuit is a 6-transistor static random access memory (SRAM). The memory circuit comprises pass transistors 505 and 506 operative to simultaneously turn on when the voltage on word line 513 is pulled high by a row select circuit (not shown.) P-channel FET 509 and n-channel FET 507 form a first inverter and p-channel FET 510 and n-channel FET 508 form a second inverter. Complementary image data is loaded onto bit line 503 (Bros) and onto bit line 504 (B_{NEG}). When pass transistor 505 is turned on by a voltage applied to WLINE 513, the data loaded onto bit line 503 is asserted onto the drain of p-channel FET 509 and the drain of n-channel FET 507 and onto the gates of p-channel FET 510 and n-channel FET 508. Similarly, when pass transistor 506 is turned on by a voltage applied to WLINE 513, the data loaded onto bit line 504 is asserted onto the drain of p-channel FET 510 and the drain of n-channel FET 508 and onto the gates of p-channel FET 509 and n-channel FET 507.

The sources of p-channel FETs 509 and 510 are connected to V_{DDAR} (V_{DD} array) over conductor 511 and the sources of n-channel FETs 507 and 508 are connect to V_{SS} (ground) over conductor 512.

Noting that the data on bit line 503 is complementary to the data on bit line 504, the line that holds the 0 data at the lower voltage is more effective at changing the state of the memory circuit. The inverse of the resulting state of the memory circuit asserted onto data signal conductor 514 (S_{NEG}). Specifically, if the data state of the memory circuit is high, then the output on conductor 514 is low and vice versa. The output S_{NEG} of the SRAM is asserted onto the input of an optional non-inverting buffer comprising inverter 563a and inverter 563b as previously noted.

More detail regarding the functions of an SRAM memory circuit are available in many sources. Applicant cites previously referenced ONG, “Modern MOS Technology; Processes, Devices and Design”, Ong, McGraw-Hill, New York, 1984, pp. 207-208, as a more detailed explanation, the contents whereof are incorporated herein by reference.

A first current and modulation section comprises p-channel FET 522a and p-channel FET 526a, forming a first reference current/current source pair on the current and modulation section and p-channel FET 534a operative to impose a data driven modulation on the current and modulation section.

The first current and modulation circuit receives the output of the memory circuit from the non-inverting buffer comprising inverters 563a and 563b over data signal conductor 514 and uses this to modulate the current generated in the current and modulation circuit. P-channel reference current FET 522a and p-channel current source FET 526a form a current mirror circuit. The voltage bias level of reference current FET 522a is set by the bias circuit comprising large L n-channel bias FET 530a wherein the drain of large L n-channel bias FET 530a is connected to the gate and drain of p-channel reference current FET 522a over conductors 546 and 525. The source of bias FET 530a is connected to V_{SS} (Ground) over conductor 533. The source of p-channel reference current FET 522a is connected to a global supply voltage V_H asserted on conductor 543. The value of V_H is independent of V_{DDAR} and is selected so that the correct operating voltage is asserted onto the anode of emissive device 555 in conjunction with a second global voltage V_L asserted onto its cathode over conductor 557 as explained below. The source of current source FET 526a is also connected to global voltage V_H asserted on conductor 543.

Current source FET 526a mirrors the reference current generated by reference current FET 522a. As is well known in the art, the current from p-channel current source FET 526a may be the same as the current from reference current FET 522a or may greater or less depending on differences in the ratio of width to length between the physical instantiations of reference current FET 522a and current source FET 526a. The W/L ratio of current source FET 526a may be scaled up or down relative to the W/L ratio of reference current FET 522a to either scale the current down or up. Those of skill in the art will recognize that for a given conductor material, length and thickness, an increase in width will reduce the resistance.

The current output on the drain of current source FET 526a is asserted on the source of p-channel data modulation FET 534a. As a p-channel device, data modulation FET 534a will assert the signal on its source onto its drain (minus a threshold voltage) when the signal asserted on its gate is low. The signal asserted on the gate of 534a is effectively S_{NEG}, which is the complement of its data state of the memory circuit, as previously noted. The drain of FET 534a is asserted onto the anode of emissive device 555. The apparent brightness of emissive device 555 will depend on the magnitude of the current asserted on its anode integrated over time. An increase in off time due to the actions of modulation FET 534a will reduce the apparent brightness of the emissive device. The cathode of emissive device 555 is connected to a global voltage V_L asserted onto conductor 557, wherein V_L is independent of rail voltages V_{DDAR} and V_{SS}. In one embodiment all cathodes are connected to the same global voltage V_L in a common cathode arrangement. In one embodiment, V_L is equal to V_{SS}.

The bias circuit comprises large L bias n-channel FET 530a and connections to other circuit elements. The source of large L n-channel bias FET 530a is connected to V_{SS} over conductor 533. The gate of bias FET 530a is connected to a bias reference voltage V_{BIAS} supplied from a source external to the pixel drive circuit over terminal 549a. In one embodiment, V_{BIAS} is supplied by a temperature stabilizing device operative to adjust V_{BIAS} in response to changing temperature to ensure that the current from the current mirror does not vary beyond a small amount as a function of temperature.

All active pixel drive circuits must have a biasing circuit as described. Not all pixel drive circuits may be required to be active in a particular instantiation of an array of pixel drive circuits formed from pixel drive circuits such as that of this figure. In those instances where the underlying pixel drive circuit is not to be connected to an emissive device through a metal layer, the source and drain of large L n-channel FET 530a may be connected to ground.

The operation of reference current FET 522b and current source FET 526b are identical to that of reference current FET 522a and current source FET 526a, and the operation of modulation FET 534b is identical to the operation of modulation FET 534a. The source of reference current FET 522b connects to conductor 543 biased to V_H over conductor 560. Modulation FET 534b received its modulation signal over conductor 561 and conductor 514 from non-inverting buffer comprising inverters 563a and 563b in series.

The operation of bias FET 530b is identical to that of bias FET 530a. The source of bias FET 530b is connected to V_{SS} over conductor 533. The gate of bias FET 530b is connected over terminal 549b to the same bias reference voltage V_{BIAS} that the gate of bias FET 530a is connected to over terminal 549a. The drain of bias FET 530b is connected over conductor 546b and conductor 525b to the gate and drain of reference current FET 522b and to the gate of current source FET 526b. The operation is identical.

This presents a functional pixel drive circuit 500 comprising two current mirror circuits that eliminates the need for an additional SRAM memory element. This can be extended to a wider number of pixel drive circuits that together form a part of a block of pixel drive circuits that can recreate a current that approximates a binary weighted current value at least partially.

FIG. 5B depicts a pixel drive circuit 600 which is a modified version of the pixel drive circuit 500 from FIG. 5A. The modification is primarily in the way the bias current FET is implemented. For pixel drive circuit 600, the SRAM circuit and non-inverting buffer of pixel drive circuit 500 of FIG. 5A is retained. The numbering of the various components of that section are unchanged and the detailed description is not repeated.

A first current and modulation section comprises p-channel FET 622a and p-channel FET 626a, forming a first reference current/current source pair on the current and modulation section and p-channel FET 634a operative to impose a data driven modulation on the current and modulation section.

The first current and modulation circuit receives the output of the memory circuit from the non-inverting buffer comprising inverters 563a and 563b over data signal conductor 614 and uses this to modulate the current generated in the current and modulation circuit. P-channel reference current FET 622a and p-channel current source FET 626a form a current mirror circuit. The voltage bias level of reference current FET 622a is set by a bias circuit comprising large L n-channel bias FET 630 wherein the drain of large L n-channel bias FET 630 is connected to the gate and drain of p-channel reference current FET 622a over conductors 646 and 625a. The source of bias FET 630 is connected to V_{SS} over conductor 633. The source of p-channel reference current FET 622a is connected to a global supply voltage V_H asserted on conductor 643. The value of V_H is independent of V_{DDAR} and is selected so that the correct operating voltage is asserted onto the anode of emissive device 655 in conjunction with a second global voltage V_L asserted onto its cathode over conductor 657 as explained below. The source of current source FET 626a is also connected to global voltage V_H asserted onto conductor 643.

Current source FET 626a mirrors the reference current generated by reference current FET 622a. As is well known in the art, the current from p-channel current source FET 626a may be the same as the current from reference current FET 622a or may greater or less depending on differences in the ratio of width to length between the physical instances of reference current FET 622a and current source FET 626a. The W/L ratio of current source FET 626a may be scaled up or down relative to the W/L ratio of reference current FET 622a to either scale the current down or up. Those of skill in the art will recognize that for a given conductor material, length and thickness, an increase in width will reduce the resistance.

The current output on the drain of current source FET 626a is asserted on the source of p-channel data modulation FET 634a. As a p-channel device, FET 634a will assert the signal on its source onto its drain (minus a threshold voltage) when the signal asserted on its gate is low. The signal asserted on the gate of 634a is effectively S_{NEG}, which is the complement of its data state of the memory circuit, as previously noted. The drain of data modulation FET 634a is asserted onto the anode of emissive device 655. The apparent brightness of emissive device 655 will depend on the magnitude of the current asserted on its anode integrated over time. An increase in off time due to the actions of modulation FET 634a will reduce the apparent brightness of emissive device 655. The cathode of emissive device 655 is connected to a global voltage V_L asserted onto conductor 657, wherein V_L is independent of rail voltages V_{DDAR} and V_{SS}. In one embodiment all cathodes are connected to the same global voltage V_L in a common cathode arrangement. In one embodiment, V_L is equal to V_{SS}.

The bias circuit comprises large L bias n-channel FET 630 and connections to other circuit elements. The source of large L n-channel bias FET 630 is connected to V_{SS} over conductor 633. The gate of bias FET 630 is connected to a bias reference voltage V_{BIAS} supplied from a source external to the pixel drive circuit over terminal 649. In one embodiment, V_{BIAS} is supplied by a temperature stabilizing device operative to adjust V_{BIAS} in response to changing temperature to ensure that the current from the current mirror does not vary beyond a small amount as a function of temperature.

All active pixel drive circuits must have a biasing circuit as described. Not all pixel drive circuits may be required to be active in a particular instantiation of an array of pixel drive circuits formed from pixel drive circuits such as that of this figure. In those instances where the underlying pixel drive circuit is not to be connected to an emissive device through a metal layer, the source and drain of large L n-channel FET 630 may be connected to ground.

The operation of reference current FET 622b and current source FET 626b are identical to that of reference current FET 622a and current source FET 626a, and the operation of modulation FET 634b is identical to the operation of modulation FET 634a. The source of reference current FET 622b connects to conductor 643 biased to V_H over conductor 660. Modulation FET 634b received its modulation signal over conductor 661 and conductor 614 from non-inverting buffer comprising inverters 563a and 563b.

The operation of bias FET 630 includes providing the same bias voltage supplied to the drain and gate of reference current FET 622a and the gate of current source FET 626a which together form a first current mirror circuit and to the gate and drain of reference current FET 622B and the gate of current source FET 626b which together former a second current mirror circuit. Providing bias voltage in this manner provides some assurance that the operation of both current mirror circuits will be closer to one another.

This presents a functional pixel drive circuit 600 comprising two current mirror circuits with a common memory circuit and a common bias FET. This can be extended to a wider number of pixel drive circuits that together form a part of a block of pixel drive circuits that can recreate a current that approximates a binary weighted current value at least partially. The use of a common bias FET will help reduce current and voltage variations between differing pixel drive circuits.

FIG. 5C depicts a pixel drive circuit 700 which is a modified version of the pixel drive circuit 600 from FIG. 5B and shares some elements with pixel drive circuit 500 from FIG. 5A. The modification simplifies the overall circuit by eliminating one reference current circuit and by making the second current source circuit a mirror of the remaining reference current circuit. For pixel drive circuit 700, the SRAM circuit and non-inverting buffer of pixel drive circuit 500 of FIG. 5A is retained. The numbering of the various components of that section are unchanged and the detailed description is not repeated.

Reference current FET 722 has its gate and drain connected in diode mode over conductor 725 and conductor 746 and to the gate of current source FET 726a over conductors 725,746 and 765 and to the gate of current source FET 726b over conductor 725. The source of reference current FET 722 and the sources of current source FETs 726a and 726b are all connected to a voltage V_H on conductor 743. In one embodiment, reference current FET 722 and current source FETs 726a and 726b are substantially identical FETs. Therefore, subject to the previously noted constraints, current source FETs 726a and 726b can provide together a current approximately twice the reference current provided by reference current FET 722.

Large L n-channel bias FET 730 is operative to bias the current mirror circuit comprising reference current FET 722 and current source FETs 726a and 726b. The source of bias FET 730 connects to V_{SS} (ground) over conductor 733. An externally supplied voltage V_{BIAS} is asserted onto the gate of bias FET 730 over terminal 749. The drain of bias FET 730 is asserted over conductor 746 and conductor 725 onto the drain and gate of reference current FET 722 and onto the gate of current source FET 726b and onto the gate of current source FET 726a over conductors 746, 725 and 765. This places the current mirror circuit in a condition for the current of reference current FET 722 to be mirrored by current source FETs 726a and 726b at a required voltage.

The current on the drain of current source FET 726a is asserted onto conductor 777, which combines that current with the current on the drain of current source FET 726b asserted onto conductor 766. Conductor 766 connects to the source of data modulation FET 734. Data modulation FET 734 receives its data state over conductor 714 from non-inverting buffer comprising inverter 563a and 563b, which together reflect the state of signal S_{NEG} from the SRAM memory circuit. When the SRAM memory circuit is placed to an on state, S_{NEG} is low. When asserted through the non-inverting buffer the low state placed on the gate of data modulation FET 734 causes that FET to conduct, thereby asserting a voltage over conductor 778 onto the anode of emissive device 755. The voltage will be pulse width modulated as the data state of the SRAM memory circuit is changed. The cathode of emissive device 755 is connected to low state voltage V_L asserted over conductor 757. Voltage V_L is normally a global or semiglobal voltage used for all LEDs. It may be less than, equal to, or greater than V_{SS}. For design reasons, it may be better to implement the data modulation FET in two instances for current handling reasons, but that is not the only manner in which adequate current handling can be achieved.

This presents a functional pixel drive circuit 700 which uses an expanded number of current source FETs duplicating a single reference current FET. This circuit may be considered a single current mirror circuit or a plurality of current mirror circuits. Additional current source FETs beyond the two described may be used to achieve higher current subblocks of block of pixel drive circuit 450 as described for FIG. 4A. The area required is not likely to be as large as for pixel drive circuit 500 of FIG. 5A or pixel drive circuit 600 of FIG. 5B for a given current capability.

In practice a combination of circuit 500 of FIG. 5A, circuit 600 of FIG. 5B and circuit 700 of FIG. 5C may be found in the group of parallel pixel driver circuits used to drive a single emissive device as previously described.

FIG. 6A depicts block of pixel drive circuits 800, operative to drive a single emissive element (not shown) such as an LED or a μLED mounted to conductive pad 801 that receives the output of all pixel drive circuits in block of pixel drive circuits 800. The rows indicated as 810 through 814 refer to rows 0 through 4 and the columns indicated as 820 through 824 refer to columns 0 through 4.

Each square represents the footprint of a pixel drive circuit. The coordinates for each pixel drive circuit is represented by a number in parentheses in the form (x, y) where the first numeral represents the row and the second numeral represents the column in which the pixel drive circuit is found. Thus column 820 is the 0^{th} column, 821 is the 1^{st} column and so forth till column 824 is the 4^{th} column. In like manner, row 810 is the 0^{th} row, row 811 is the 1^{st} row and so forth till row 814 is the 4^{th} row.

Each square representing the position of a pixel drive circuit includes a number comprising one of 1, 2 4, 8 or 10. These numbers indicate that the marked square representing a pixel drive circuit is a part of a sub-block of pixel drive circuits operated together as previously described for FIGS. 5A-5C to provide a gray scale value of the relative intensity of the associated number. Therefore, the number 1 is associated only with the pixel drive circuit at (4, 0). A circuit similar to emissive pixel circuit 500 with its memory circuit at that coordinate would be suitable for this pixel drive circuit.

The number 2 is located at the pixel drive circuits at (2, 3) and 2, 4), providing substantially twice the current provided by the pixel drive circuit at (4, 0). For this example, the single memory circuit for both pixel drive circuits is assumed to be located in the pixel drive circuit at (2,3). This and the remaining pixel drive circuits that follow may comprise variations on the pixel drive circuits 600 of FIG. 5B or 700 of FIG. 5C.

The number 4 is located at the pixel drive circuits (3, 3), (3, 4), (4, 3) and (4, 4), providing substantially four times the current provided by the pixel drive circuit (4, 0). For this example, the single memory circuit for all four pixel drive circuits is assumed to be located in the pixel drive circuit at (4, 4).

The number 8 is located at the pixel drive circuits at (1, 1), (2, 0), (2, 1), (3, 0), (3, 1), (3, 2), (4, 1), and (4, 2), providing substantially eight times the current provided by the pixel drive circuit at (4, 0). For this example, the single memory circuit for all eight pixel drive circuits is assumed to be located in the pixel drive circuit at (2, 1).

The number 10, representing pixel drive circuits generating a non-binary modulation weighted to 10, is locate at the pixel drive circuits at (0, 0), (0, 1), (0, 2), (0, 3), (0, 4), (1, 0), (1, 2), (1, 3), (1, 4) and (2, 2) providing 10 times the current provided by the pixel drive circuit at (4, 0). For this example, the single memory circuit for all 10 pixel drive circuits is assumed to be located in the pixel drive circuit at (2, 2).

As stated above, the memory circuits for pixel sub-blocks for 2, 8, and 10 are located at (2, 3), (2, 1) and (2, 2) respectively, thus placing them all on the second row indicated by arrow 802a. The memory circuits for pixel sub-blocks 1 and 4 are located at (4, 0) and (4, 4) respectively, thus placing them all on the fourth row, indicated by arrow 802b. For ease of reference, the pixel drive circuits configured with memory circuits have their sub-block numbers underlined.

By inspection, it is clear that only the rows with memory circuits require word lines to enable data to be written to those memory circuits. Because all pixel drive circuits in an on state contribute to the desired modulation current which determines the intensity of the radiation of the emissive element, it is important that all word lines required to be active to write image data to the memory circuits of the rows of blocks of pixel drive circuits need to be activated as close to one another in time as is possible. One method for accomplishing this is to operate all word lines within a row of blocks of pixel drive circuits in immediate succession in order to write all memory circuits of the row of pixel drive circuits as rapidly as possible.

FIG. 6B presents a block diagram of a controller/backplane combination 830 operative to provide modulation data to the memory circuits of a block of pixel drive circuits. A display controller comprises static voltage section 831a, signal voltage control section 831b and data memory and logic control section 831c. A first row of blocks of pixel drive circuits comprises block of pixel drive circuits 832a1 and block of pixel drive circuits 832a2. A second row of blocks of pixel drive circuits comprises block of pixel drive circuits 832b1 and block of pixel drive circuits 832b2. A third row of blocks of pixel drive circuits comprises block of pixel drive circuits 832c1 and block of pixel drive circuits 832c2. A first column of blocks of pixel drive circuits comprises block of pixel drive circuit 832a1, block of pixel drive circuits 832b1 and block of pixel drive circuits 832c1. A second column of blocks of pixel drive circuits comprises block of pixel drive circuits 832a2, block of pixel drive circuits 832b2 and block of pixel drive circuits 832c2. The choice of this number of pixel drive circuits in FIG. 6B is for ease of reference and is not limiting upon this disclosure. Arrays of pixel drive circuits comprising in excess of 1000 rows and 1000 columns are commonplace in products for both display purposes and non-display purposes. The blocks of pixel drive circuits each require two separate row write actions in order for all memory circuits of each block of pixel drive circuits on each row of blocks of pixel drive circuits to be written with data, in a manner similar to that disclosed for block of pixel drive circuits 600 of FIG. 6A.

Static voltage section 831a provides a set of voltages required to operate the array of pixel drive circuits, said voltages comprising V_{DDAR}, V_{SS}, upper drive voltage V_H and cathode return voltage V_L loaded onto static voltage distribution bus 833a. Static voltage distribution bus 833a distributes V_{DDAR}, V_H, V_{SS} and V_L to the blocks of pixel drive circuits of a first row over conductor 837a, to the blocks of pixel drive circuits of a second row of blocks of pixel drive circuits over conductor 837b and to the block of pixel drive circuits of a third row of blocks of pixel drive circuits over conductor 837c, wherein each of conductors 837a, 837b and 837c comprises at least one separate conductor for each supplied static voltage.

Signal voltage control section 831b delivers control signals required to operate the array of pixel drive circuits, such as word line (WLINE) high for the selected row, over bus 833b. Signal voltage control section 831b delivers signals to signal voltage distribution bus 833b, which in turn delivers the signals to the block of pixel drive circuits of a first row of blocks of pixel drive circuits over a first conductor (not shown), to the block of pixel drive circuits of a second row of blocks of pixel drive circuits over a second conductor (not shown) and to the blocks of pixel drive circuits of a third row of blocks of pixel drive circuits over a third conductor (not shown). These conductors each may comprise a plurality of conductors such that each control signal is delivered independently of other control signals. The row of blocks of pixel drive circuits on which a first WLINE is to be held high is selected by a row decoder circuit disclosed in conjunction with the following description of data memory and logic control section 831c Timing of the signal voltages and their application to the circuit are typically controlled by an executive function such as data memory and logic control section 831c. The word line for the selected row is one of conductor 893a1, conductor 831a2, conductor 839b1, conductor 831b2, conductor 831c1 or conductor 839c2, as determined by the state of each row decoder set by data memory and logic control section 831c.

Data memory and logic control section 831c performs several functions. It may, for example, translate modulation data received in a standard 8-bit 10-bit or 12-bit format into a form usable to pulse-width modulate a display. A first function is to select a row for data to be written to and a second function is to load the data to be written to that row. Data memory and logic control section 831c loads image data onto column (bit line) drivers 841a and 841b over bus 835. Conductors 834a1 and 834a2 represent a first pair of complementary bit lines that route data to the first column. Conductors 834b1 and 834b2 represent a second pair of complementary bit lines that route data to the second column. Each of the pair of complementary bit lines are operative to transfer data from column drivers 841a or 841b respectively to the memory circuits of each block of pixel drive circuits of the selected row within the block. Data memory and logic control section 831c loads the selected address information onto address data bus 833c, which acts to select the correct row using row decoder circuits 840a1 and 840a2, row decoder circuits 840b1 and 840b2, and row decoder circuits 840c1 and 840c2, each positioned on address data bus 833c. When WLINE for the selected row is held high, the data on the bit line drivers are loaded into the memory circuit of each pixel of the selected row.

In one embodiment, the two row decoders for different rows within a single block of pixel drive circuits may decode to drive the word line in response to the same word line address, provided that no two memory circuits of the word line driver circuits of the block are configured to receive data over the same bit lines when the word line for that memory circuit is high. For example, row decoder circuit 840a1 and 840a2 may be designed so that both are selected by the same row address. Similar considerations would apply to all other row decoder pairs, such as row decoder pair 840b1 and 840b2 and row decoder pair 840c1 and 840c2.

In another embodiment, one of the two row decoders for different rows within a single block of pixel drive circuits is eliminated and the same row decoder and word line driver is used to drive both word lines. Again, no two memory circuits may be configured to receive data over the same bit lines. For example, Row decoder 840a2 is eliminated and row decoder 840a1 drives both word line 339a1 and word line 839a2.

In another embodiment, only row decoder 840a1 and word line 839a1 are retained. Row decoder 840a2 and word line 839a2 are eliminated. The memory circuits are physically laid out so that each memory circuit can be accessed by the single word line. This does not require that they all be placed on the same row and in fact some memory circuits may be located on one side of the word line and some on the other.

Column (bit line) drivers 841a and 841b may each comprise a tri-state buffer and a memory circuit, wherein the memory circuit asserts its output onto the tri-state buffer. The tri-state buffer further comprises an enable terminal and an output. When a signal is received from data memory and logic control section on the enable terminal, the value asserted on the input of the tri-state memory circuit is then asserted onto its output. This provides a measure of control over the loading of data onto the bit lines.

The next consideration is how best to take advantage of the flexibility of the use of addressable word lines in conjunction with the ability to turn individual section of pixel drive circuits within each block in order to adjust the current value. The use of pulse width modulation in conjunction with the variable current can increase significant the bit depth that can be created for each pixel.

FIGS. 6C and 6D present depictions of modulation sequence 850a and 850b, which together illustrate one method of implementing pulse width modulation on rows comprising a plurality of pixel drive circuits wherein more than one row write action is required to fully turn on all pixel drive circuits of the blocks of pixel drive circuits. Block of pixel drive circuits 800 of FIG. 6A is an example of a block of pixel drive circuits requiring two separate row write actions to write image data to the memory circuits of all pixel drive circuits of the block. FIG. 6C is based in part on FIG. 8B of U.S. patent application Ser. No. 10/435,427, now U.S. Pat. No. 8,421,828 and its continuations as previously cited.

The depiction of modulation sequence 850a presents the rows of blocks of emissive elements (vertical axis) written by row write actions as a function of time (horizontal axis.) The number in each square indicates the sequence in which modulation takes place. Referring to row write actions 1 and 2 on row 7, row write action 1 and row write action 2 take place on different rows within the same block of pixel drive circuits. Row write action 1 may take place on the row indicated by arrow 802a and row write action 2 may take place on the row indicated by arrow 802b of block of pixel drive circuits 800 of FIG. 6A. Logically the order is arbitrary although there may be engineering reasons related to current flow to prefer one over the other. Modulation sequence 850a is divided into three subsections; subsection 851 comprising row write actions 1 through 6, subsection 852 comprising row write actions 7 through 12 and subsection 853 comprising row write actions 13 through 18.

Modulation sequence 850a comprises a first modulation sequence of three pairs of row write actions in subsection 851 comprising pair 1 and 2 on row 7, pair 3 and 4 on row 5, and pair 5 and 6 on row 1. The row spacing between pair 1 and 2 and pair 3 and 4 is two rows and the row spacing between pair 3 and 4 and pair 5 and 6 is four rows. All subsequent sets of three pairs of row write actions follow the same order and the same pattern of row spacings.

The second instance of the modulation sequence of three pairs of row write actions, found in subsection 852, comprises pair of row write actions 7 and 8 on row 8, pair of row write actions 9 and 10 on row 6, and pair of row write actions 11 and 12 on row 2. The row spacing between pair of row write actions 7 and 8 and pair of row write actions 9 and 10 is again two rows and the row spacing between pair of row write action 9 and 10 and pair of row write actions 11 and 12 is again four rows. Thus the pattern of row write actions in subsection 852 repeats the patterns of row write actions found in subsection 851 with a single row offset.

The third instance of the modulation sequence of three pairs of row write actions, found in subsection 853, comprises pair of row write actions 13 and 14 on row 9, pair of row write actions 15 and 16 on row 7, and pair of row write actions 17 and 18 on row 3. The row spacing between pair of row write actions 13 and 14 and pair of row write actions 15 and 16 is again two rows and the row spacing between pair of row write action 15 and 16 and pair of row write actions 17 and 18 is again four rows. Thus the pattern of row write actions in subsection 853 repeats the patterns of row write actions found in subsections 851 and 852 with one row offset from subsection 852.

Another point of consideration is that pair of row write actions 15 and 16 on row 7 overwrites the data written by pair of row write actions 1 and 2 of subsection 851. The number of time intervals from the start of the first pair of row write actions 1 and 2 on row 7 to the start of subsequent pair of row write actions 15 and 16 is 14 time intervals. The time intervals during which subsequent pair of r row write action 15 and 16 are counted for the next time interval.

The fourth instance of the modulation sequence of three pairs of row write actions, found in subsection 854 of modulation sequence 850b of FIG. 6D, again repeats the same pattern of row spacings in the same order. The row spacing between pair of row write actions 19 and 20 and pair of row write actions 21 and 22 is again two rows and the row spacing between pair of row write action 21 and 22 and pair of row write actions 23 and 24 is again four rows. Thus the pattern of row write actions in subsection 854 repeats the patterns of row write actions found in subsections 851, 852 and 853 with one row offset from subsection 853.

As with the previous subsection, pair of row write actions 21 and 22 on row 8 overwrites the data previously written on row 8 by pair of row write actions 7 and 8 of subsection 852. Again the time spacing is 14 time intervals.

The fifth instance of the modulation sequence of three pairs of row write actions, found in subsection 855 of modulation sequence 850b of FIG. 6D, again repeats the same pattern of row spacings in the same order. The row spacing between pair of row write actions 25 and 26 on row 11 and pair of row write actions 27 and 28 on row 9 is again two rows and the row spacing between pair of row write action 27 and 28 on row 9 and pair of row write actions 29 and 30 on row 5 is again four rows. Thus the pattern of row write actions in subsection 854 repeats the patterns of row write actions found in subsections 851, 852 and 853 with one row offset from subsection 853.

As with the previous subsection, pair of row write actions 27 and 28 on row 9 overwrites the data previously written on row 9 by pair of row write actions 13 and 14 of subsection 853. Again the time spacing is 14 time intervals.

Additionally, pair of row write actions 29 and 30 written on row 5 overwrite the data previously written on row 5 by row write actions 3 and 4 for a spacing of 26 time intervals.

The sixth instance of the modulation sequence of three pairs of row write actions, found in subsection 856 of modulation sequence 850b of FIG. 6D, again repeats the same pattern of row spacings in the same order. The row spacing between pair of row write actions 31 and 32 and pair of row write actions 33 and 34 is again two rows and the row spacing between pair of row write action 33 and 34 and pair of row write actions 35 and 36 is again four rows. Thus the pattern of row write actions in subsection 856 repeats the patterns of row write actions found in the previous subsections 851-855 with one row offset from subsection 855.

As with the previous subsection, pair of row write actions 33 and 34 on row 10 overwrites the data previously written on row 10 by pair of row write actions 19 and 20 of subsection 854 with a resulting time spacing equal to 14 time intervals.

Pair of row write actions 35 and 36 written on row 6 overwrite the data previously written on row 6 by row write actions 9 and 10 in subsection 852 for a spacing of 26 time intervals.

Review of the forgoing material establishes that for the given row spacing established first in subsection 851, a row spacing of 2 rows results in a time spacing of 14 intervals and a row spacing of 4 rows results in a time spacing of 26 time intervals. Adding additional pairs of row write actions to the repeating sequence with different row spacings will result in additional time interval spacings.

This can be used to create a gray scale modulation based on time that supplements the earlier disclosed method of using multiple parallel current source circuits to provide modulation based on the level of current. Those of ordinary skill in the art will recognize that this can largely be implemented through the use of lookup tables.

Those of skill in the art will recognize minor variations to the depicted embodiments. The depicted embodiments are not to be considered limiting on the present invention.

1. A backplane forming part of a display comprising an array of emissive elements, the backplane comprising:
a plurality of blocks of pixel drive circuits, each comprising a plurality of columns of blocks of pixel drive circuits and a plurality of rows of blocks of pixel drive circuits, and wherein each block comprises a plurality of columns of pixel drive circuits and a plurality of rows of pixel drive circuits, and wherein the number of rows and columns of pixel drive circuits in each block is the same as all other blocks of pixel drive circuits, and wherein each pixel drive circuit is a current source controlled by a memory circuit, and wherein
the pixel drive circuits of each block of pixel drive circuits are configured electrically in parallel such that their outputs are connected to a single conductive pad for each block of pixel drive circuits, to which conductive pad an emissive element is to be affixed, and wherein
each pixel drive circuit provides a designed current substantially at the designed voltage in response to on state data stored on its associated memory circuit, and wherein the design voltages of all pixel drive circuits are substantially the same, and wherein
each memory circuit of the backplane is written with data in response to a row select action on a word line acting on that memory circuit to enable it to receive new data from a column driver delivered over at least one bit line, and wherein
at least one word line connects to the memory circuits of each block of pixel drive circuits.

2. The backplane of claim 1, wherein the memory circuit is a Static Random Access Memory (SRAM) and the at least one bit line is a pair of bit lines with complementary data loaded on the bit lines.

3. The backplane of claim 1, wherein each of the current sources comprises a current mirror circuit, the current mirror circuit comprising a reference current FET, a bias FET and at least one current source FET.

4. The backplane of claim 1, wherein each current source of a block of pixel drive circuits is of substantially equal current weighting and wherein each current source of a block of pixel drive circuits is controlled by a separate memory circuit, and wherein each memory circuit of pixel drive circuits on the same row within a block of pixel drive circuits are responsive to the same word line, and wherein all memory circuits in the same column of pixel drive circuits of a block of pixel drive circuits are connected to the same bit lines.

5. The backplane of claim 4, wherein the word lines of all rows of a block of pixel drive circuits are operated at time intervals corresponding to a first rate of operation, the interval being the time beginning when the first word line of the block of pixel circuits through the operation of all other word lines of the block of pixel circuits and ending when the first word line is again operated, and wherein the word line of a single row of a block of pixel drive circuits is operated at a second rate that is an integer n times more often than the first rate, and wherein at least one pixel drive circuit of the single row controlled by the word line operated at the second rate is used to create a pulse width modulation of a short duration corresponding to a 1/n minimum duration and a n/n maximum duration each multiplied by the time interval corresponding to the first rate.

6. The backplane of claim 1, wherein a single memory circuit controls only one current source of a block of pixel drive circuits and wherein all remaining memory circuits control at least one current source of the same block of pixel drive circuits.

7. The backplane of claim 6, wherein a plurality of the all remaining memory circuits each control differing numbers of current sources.

8. The backplane of claim 7, wherein at least one memory circuit controls current sources with the current substantially twice that of the one memory circuit controlling one current source and wherein at least one memory circuit controls current sources with the current substantially four times the single current source controlled by one memory circuit.

9. The backplane of claim 8, wherein additional memory circuits each control a plurality of current sources with a total current output that is binary weighted multiples of the current output from the single current source controlled by a single memory circuit.

10. The backplane of claim 3, wherein the at least one current source FET of a first current source comprises a first plurality of current source FETs and wherein the at least one current source FET of a second current source comprises a second plurality of current source FETs, wherein the number of current source FETs of the first plurality of current source FETs is not equal to the number of current source FETs of the second plurality of current source FETs.

11. The backplane of claim 10, wherein the current output of the first plurality of current source FETs is substantially binary weighted relative to the current output of a single current source FET, and wherein the current output of the second plurality of current source FETs is substantially binary weighted to a binary weighting relative to the current output of a single current source FET, and wherein the current output of the first plurality of current source FETs represents a different binary weight than the current output of the second plurality of current source FETs.

12. The backplane of claim 3, wherein at least one of the current sources comprises a current mirror circuit comprising a plurality of current source FETs controlled by a single memory circuit.

13. The backplane of claim 12, wherein each block of pixel drive circuits is organized into a plurality of sub-blocks of pixel drive circuits, wherein at least a plurality of the sub-blocks of pixel drive circuits each comprise a plurality of current sources each comprising current source FETs wherein all current sources of each of the plurality of sub-block comprising a plurality of current sources are controlled by the same memory circuit.

14. The backplane of claim 13, wherein the current output of a plurality of the sub-blocks of pixel drive circuits comprising a plurality of current sources controlled by a single memory circuit are each substantially binary multiples of the current output of a non-pulse width modulated current source equivalent to a least significant bit.

15. The backplane of claim 13, wherein the current output of a current source equivalent to a least significant bit results from a current source comprising one non-pulse width modulated current source FET.

16. The backplane of claim 14, wherein the current output of each of the sub-blocks of pixel drive circuits comprises one of either a binary weighted current output or a non-binary weighted current output relative to the current output of a current source equivalent to a non-pulse width modulated least significant bit.

17. The backplane of claim 16, wherein more than one instance of a sub-block of a particular binary or non-binary weight is found in a block of pixel drive circuits.

18. The backplane of claim 1, wherein, within a block of pixel drive circuits, a first plurality of current sources are controlled by a lesser plurality of memory circuits.

19. The backplane of claim 18, wherein all pixel drive circuits of a block of pixel drive circuits are controlled by a plurality of memory circuits, wherein all of the plurality memory circuits is placed in a condition to receive data by the action of a single word line, and wherein each memory circuit receives data over a bit line separate from the bit lines delivering data to all other memory circuits.

20. The backplane of claim 19, wherein the backplane is pulse width modulated by writing data to the memory circuits of a first row of blocks of pixel drive circuits by operating the single word line thereof, after which a second row of blocks of pixel drive circuits at a first row spacing from the first row of pixel drive circuits receives data written to the memory circuits thereof by operating the single word line of the second row of blocks of pixel drive circuits, after which a third row of pixel drive circuits at a second row spacing from the second row of pixel drive circuits receives data written to the third row thereof by operating the single word line of the third row of blocks of pixel drive circuits, wherein the row spacing between the first row of blocks of pixel drive circuits and the second row of block of pixel drive circuits differs from the row spacing between the second row of blocks of pixel drive circuits and the third row of blocks of pixel drive circuits, and wherein, after completing the writing of blocks of pixel drive circuits, the pattern is repeated at a point offset from the earlier first row of blocks of pixel drive circuits by one row of blocks of pixel drive circuits.

21. The backplane of claim 18, wherein all pixel drive circuits of a block of pixel drive circuits are controlled by a plurality of memory circuits, wherein a plurality of separate word line actions on separate word lines within the block of pixel drive circuits are required to place all memory circuits in the block of pixel drive circuits in a condition to receive data in a time sequential manner, and wherein all memory circuits operated by a single one of the plurality of word line circuits receive data over separate bit lines, and wherein memory circuits in a block of pixel drive circuits not operated by the same word line optionally share the same bit lines,

22. The backplane of claim 21, wherein the backplane is pulse width modulated by writing data to the memory circuits of a first row of blocks of pixel drive circuits by operating the plurality of word lines of that first row of blocks of pixel drive circuits in immediate succession such that all word lines of that first row are operated before the word lines of any other row of blocks of pixel drive circuits are operated, after which data is written to the memory circuits of a second row of blocks of pixel drive circuits at a first spacing of rows of blocks of pixel drive circuits from the first row of blocks of pixel drive circuits, again with all the plurality of word lines within the second row of blocks of pixel drive circuits operated in immediate succession until all memory circuits of the second row of blocks of pixel drive circuits have been written, after which data is written to the memory circuits of a third row of blocks of pixel drive circuits at a second spacing of rows between the second row of blocks of pixel drive circuits and a third row of blocks of pixel drive circuits, with all the plurality of word lines within the third row of pixel drive circuits operated in immediate succession until all memory circuits of the third row of blocks of pixel drive circuits have had data written to them, and wherein the first spacing of rows between the first and second rows of blocks of pixel drive circuits is not equal to the second spacing of rows between the second and third rows of blocks of pixel drive circuits, and wherein, after completing the writing of the memory circuits of the last row of blocks of pixel drive circuits, the patter of row offsets is repeated beginning at a point offset from the earlier first row of blocks of pixel drive circuits by one row of blocks of pixel drive circuits.

23. The backplane of claim 1, wherein the at least one word line in a row of blocks of pixel drive circuits comprises at least two word lines in a row of blocks of pixel drive circuits.

24. The backplane of claim 23, wherein the at least two word lines in a row of blocks of pixel drive circuits are driven by row decoder and row driver assemblies that decode the same address and operate simultaneously, and wherein no memory circuit operated by the at least two word lines shares bit lines with another memory circuit operated by the at least two word lines.

25. The backplane of claim 24, wherein a plurality of the at least two word lines in a row of blocks of pixel drive circuits are driven by the same row decoder and row driver assembly, and wherein no memory circuit operated by the at least two word lines shares bit lines with another memory circuit operated by the plurality of the at least two word lines.

26. The backplane of claim 3, wherein at least two of the current sources comprise current mirror circuits comprising at least one current source FET each and a bias FET shared between the at least two current mirror circuits.

27. The backplane of claim 3, wherein at least two of the current sources comprise current mirror circuits comprising at least one current source FET each and a reference current FET shared between the at least two current mirror circuits.
